(19) United States
(12) Patent Application Publication
(10) Pub. No.: US 2026/0260189 A1
(43) Pub. Date: Sep. 3, 2026

(54) WORKFORCE OPTIMIZATION SYSTEMS AND METHODS

(71) Applicant: BCE INC., Verdun (CA)

(72) Inventors: Marco SCIARRA, Don Mills (CA); Fabio ABATE, Don Mills (CA); Maksym DOROSH, Don Mills (CA); Jawwad QADRI, Don Mills (CA); Stephen GIROUX JOLY, Verdun (CA); Benoit GOYETTE, Verdun (CA); Keane D'CUHNA, Don Mills (CA); Queenie ueenie MOK, Don Mills (CA); Melissa BLAIS, Verdun (CA); Mathew SHEEHY, Don Mills (CA); TshiTenge MUSAMPA, Verdun (CA); Ashan BHATTI, Verdun (CA); Steven CHUN, Verdun (CA); Akash MANDALIYA, Verdun (CA); Doreen XU, Verdun (CA); Danny CHAN, Verdun (CA); Young KIM, Verdun (CA); Sukumar GHOSH, Verdun (CA); Justin COOK, Verdun (CA); Montosh CHOWDHURY, Don Mills (CA); Vivek BHAVSAR, Don Mills (CA); Savannah ZHAO, Don Mills (CA); Kevin LI, Don Mills (CA); Andrew HUM, Don Mills (CA); Rong LI, Don Mills (CA); Ning BAI, Don Mills (CA); Roger GANESH, Don Mills (CA)

(21) Appl. No.: 18/873,419

(22) PCT Filed: Jul. 19, 2024
(86) PCT No.: PCT/CA2024/050961

§ 371 Date: Dec. 10, 2024

Related U.S. Application Data
(60) Provisional application No. 63/528,172, filed on Jul. 21, 2023.

(51) Int. Cl. G06Q 10/0631; G06Q 10/0637; G06Q 10/0639

(52) U.S. Cl. CPC G06Q 10/063118; G06Q 10/063116; G06Q 10/0637; G06Q 10/06398

(57) ABSTRACT

Workforce optimization systems and methods are disclosed. A workforce optimization system comprises: a hierarchy tool configured to collect and store employment information about employees of a workforce; an agent suite tool configured to collect and store employee performance data and scheduling information for the employees; a workforce planning tool configured to determine forecasted employee requirements; a budget tool configured to determine an expected budget based on the employment information and the forecasted employee requirements; a customer experience monitoring tool configured to determine a service level provided by the employees to customers; and a virtual manager configured to analyze the employment information, the employee performance data, the scheduling information, the forecasted employee requirements, the expected budget, and the service level, and determine one or more recommended actions for optimizing the workforce while maintaining the service level at or above a minimum service level.

### CROSS-REFERENCE TO RELATED APPLICATIONS

This application claims priority to U.S. Provisional Patent Application No. 63/528,172, filed on Jul. 21, 2023, the entire contents of which is incorporated herein by reference for all purposes.

### TECHNICAL FIELD

The present invention relates to workforce optimization solutions, and in particular to workforce optimization solutions supported by Machine Learning (ML) forecasting.

### BACKGROUND

Businesses use various methods and systems to optimize their workforce and their management. Businesses, such as contact centres, operate in a dynamic, always-changing environment where understanding customer demand from various different channels and segmentations and then matching demand with resources is an ever-present challenge. Human resources components may be particularly difficult to keep organized and updated.

Manual processes or multiple systems are used to update employees' statuses, scheduling, budgeting, and more. Any forecast planning, data collection, incentives, and work hours (including absences and trading shifts) take a lot of time. Time is spent collecting, validating, organizing, accessing multiple systems, comparing data from multiple systems or papers, retrieving historical data that may be present on a different means than the current data, and more, instead of efficiently analysing data and managing the workforce. Some businesses work with vendors and partners to provide various services which require coordination between all parties.

Such organization through multiple systems or papers often delays the reporting and resource planning that a business does. Employees may spend a large amount of time keeping track of the various spreadsheets and emails and organizing all the information from different sources. Incomplete or inaccurate budgets, forecast plans, and inefficient scheduling change systems result from these processes. This may further lead to poor work environments for employees and negative service conditions.

Different applications may be used to manage a workforce, however each application is purpose-built for a particular aspect of managing the workforce (e.g. human resources, budgeting, scheduling, planning, etc.) and does not interoperate with other applications. Accordingly, organizations are provided with incomplete, disparate sources of information, which hinders decision-making capabilities with respect to optimizing a workforce.

Accordingly, additional, alternative, and/or improved methods and systems to facilitate and optimize workforce management is desired.

### SUMMARY

In accordance with one aspect of the present disclosure, there is provided a workforce optimization system, comprising: a hierarchy tool configured to collect and store employment information about employees of a workforce; an agent suite tool configured to collect and store employee performance data and scheduling information for the employees; a workforce planning tool configured to determine forecasted employee requirements; a budget tool configured to determine an expected budget based on the employment information and the forecasted employee requirements; a customer experience monitoring tool configured to determine a service level provided by the employees to customers; and a virtual manager configured to analyze the employment information, the employee performance data, the scheduling information, the forecasted employee requirements, the expected budget, and the service level, and determine one or more recommended actions for optimizing the workforce while maintaining the service level at or above a minimum service level.

In some aspects, the virtual manager is configured to determine a gap between a current expected demand for employee requirements and a supply of employee availability, and to determine the one or more recommended actions to minimize the gap.

In some aspects, the virtual manager determines the current expected demand by forecasting employee requirements for a current interval.

In some aspects, forecasting the employee requirements for the current interval comprises using a machine learning model selected from a plurality of machine learning models based on accuracy of previous forecasted employee requirements compared to actual employee requirements.

In some aspects, the virtual manager determines the supply of employee availability based on an actual and expected employee availability, wherein the actual and expected employee availability is determined based on the employment information, the scheduling information, and the forecasted employee requirements.

In some aspects, the one or more recommended actions comprise one or more of: generating overtime offers to one or more employees; and determining, based on the scheduling information, one or more available employees for scheduling.

In some aspects, the one or more employees and/or the one or more available employees are determined based on performance and/or based on cost.

In some aspects, the virtual manager is configured to determine a variance between an expected actual budget for a time period and a planned budget for the time period, and to determine the one or more recommended actions to minimize the variance.

In some aspects, the planned budget for the time period is determined for the time period using the budget tool based on the employment information, the scheduling information, and the forecasted employee requirements at a time of creating the planned budget, and wherein the expected actual budget for the time period is determined using the budget tool based on the employment information, the scheduling information, and the forecasted employee requirements at a current time.

In some aspects, the workforce planning tool uses a machine learning model trained on historical employee requirements to determine the forecasted employee requirements.

In some aspects, the agent suite tool is further configured to determine recommended coaching and/or training for employees based on the performance data.

In some aspects, the agent suite tool is further configured to set targets and incentives to the employees.

In some aspects, the incentives comprise commissions and/or bonuses.

In some aspects, the targets and incentives are set for individual employees or a group of employees.

In some aspects, the budget tool determines the expected budget further based on fixed and variable cost components, and agent productivity expectations.

In some aspects, the customer experience tool determines and stores current and historical service levels.

In some aspects, the workforce comprises employees of a call center.

In some aspects, the forecasted employee requirements is based on a forecasted call volume.

In some aspects, the virtual manager is configured to generate and output a user interface for display to a user, the user interface displaying information of one or more of the employment information, the employee performance data, the scheduling information, the forecasted employee requirements, the expected budget, the service level, and the one or more recommended actions.

In some aspects, the virtual manager is configured to implement the one or more recommended actions in response to user input.

In some aspects, the virtual manager is configured to automatically implement the one or more recommended actions.

In accordance with another aspect of the present disclosure, there is provided a workforce optimization method, comprising: receiving workforce management information, the workforce management information comprising employment information about employees of a workforce, performance data of the employees, scheduling information for the employees, forecasted employee requirements, an expected budget, and a service level provided by the employees to customers; and determining one or more recommended actions for optimizing the workforce while maintaining the service level at or above a minimum service level.

In some aspects, determining one or more recommended actions for optimizing the workforce comprises determining a gap between a current expected demand for employee requirements and a supply of employee availability, and determining the one or more recommended actions to minimize the gap.

In some aspects, the method further comprises determining the current expected demand by forecasting employee requirements for a current interval.

In some aspects, forecasting the employee requirements for the current interval comprises using a machine learning model selected from a plurality of machine learning models based on accuracy of previous forecasted employee requirements compared to actual employee requirements.

In some aspects, the method further comprises determining the supply of employee availability based on an actual and expected employee availability, wherein the actual and expected employee availability is determined based on the employment information, the scheduling information, and the forecasted employee requirements.

In some aspects, the one or more recommended actions comprise one or more of: generating overtime offers to one or more employees; and determining, based on the scheduling information, one or more available employees for scheduling.

In some aspects, the method further comprises determining the one or more employees and/or the one or more available employees based on performance and/or based on cost.

In some aspects, the method further comprises determining a variance between an expected actual budget for a time period and a planned budget for the time period, and to determine the one or more recommended actions to minimize the variance.

In some aspects, the planned budget for the time period is determined for the time period based on the employment information, the scheduling information, and the forecasted employee requirements at a time of creating the planned budget, and wherein the expected actual budget for the time period is determined based on the employment information, the scheduling information, and the forecasted employee requirements at a current time.

In some aspects, the method further comprises using a machine learning model trained on historical employee requirements to determine the forecasted employee requirements.

In some aspects, the method further comprises determining recommended coaching and/or training for employees based on the performance data.

In some aspects, the method further comprises setting targets and incentives to the employees.

In some aspects, the incentives comprise commissions and/or bonuses.

In some aspects, the targets and incentives are set for individual employees or a group of employees.

In some aspects, determining the expected budget is further based on fixed and variable cost components, and agent productivity expectations.

In some aspects, the method further comprises determining and storing current and historical service levels.

In some aspects, the workforce comprises employees of a call center.

In some aspects, the forecasted employee requirements is based on a forecasted call volume.

In some aspects, the method further comprises generating a user interface for display to a user, the user interface displaying information of one or more of the employment information, the performance data, the scheduling information, the forecasted employee requirements, the expected budget, the service level, and the one or more recommended actions.

In some aspects, the method further comprises implementing the one or more recommended actions in response to user input.

In some aspects, the method further comprises automatically implementing the one or more recommended actions.

In accordance with another aspect of the present disclosure, there is provided a non-transitory computer-readable medium having computer executable instructions stored thereon which, when executed by a processor, configure the processor to implement the workforce optimization method of any one of the above aspects.

In accordance with another aspect of the present disclosure, there is provided a system for optimizing a workforce, the system comprising at least one of: an information component for storing and updated information about employees; a performance component for analysing a performance of the employees and generating a performance score for each employee; a finance component for generating a financial plan based on at least one of the information about employees and the performance scores; a forecast component for generating one or more forecast recommendations based on machine learning models and at least one of the information about employees, the performance scores, and the financial plan, and for combining one or more of the one or more forecast recommendations to output a forecast plan for execution; and a monitoring component for analysing performance of employees and robots based on statistical data of the employees and robots, and for generating and transmitting notifications based on the analysed performance of the employees and robots. The system is configured to receive and update user statuses based on the information about employees, the performance scores, and the financial plan, and automatically update a schedule based on the user statuses.

In accordance with another aspect of the present disclosure, there is provided a method of monitoring and measuring performance of a user comprising receiving user data, the user data comprising at least one of information about a number of tasks completed by the user, information about a time for each task completed, information about user attendance, and information about user qualifications; aggregating the user data to analyse pre-defined metrics against pre-set targets; determining a training for the user based on the analysed user data; automatically receiving updated user data after the user has completed the training; aggregating the updated user data to analyse the pre-defined metrics against the pre-set targets; and outputting a performance score of the user based on the analysed updated user data.

In accordance with another aspect of the present disclosure, there is provided a method of generating a finance plan comprising retrieving information on finances of individuals and groups, sales, and expenses; generating a first finance plan based on the information retrieved; receiving data about finance influences by one or more groups; receiving a selection of one or more of the finance influences; and automatically updating the first finance plan based on the selected one or more finance influences to generate the finance plan.

In accordance with yet another aspect of the present disclosure, there is provided a method of determining a forecast plan comprising receiving data about one or more groups, the data comprising social media data, finance data, performance data and historical data; automatically generating one or more recommendations based on machine learning models and received data; displaying the one or more recommendations for the user; receiving influence data from the user and automatically updating the recommendations based on the KPI data; receiving a selection of one or more of the one or more updated recommendations; generating a forecast plan based on a combination of the one or more selected recommendations; and outputting the forecast plan for execution.

In accordance with another aspect of the present disclosure, there is provided a method of monitoring and reporting operations comprising receiving statistical data comprising at least one of robotic system data, tasks completed, tasks yet to be completed, user schedules, and user performance data; aggregating the statistical data based on pre-set metrics; analysing the aggregated statistical data based on targets for each pre-set metric; and transmitting a notification if the analysed aggregated statistical data does not meet a target for a respective pre-set metric.

In accordance with another aspect of the present disclosure, there is provided a system for managing one or more groups comprising an aggregation component configured to store and combine user data, the user data comprising at least one of user information, task results, employee performance, and financial; an analysis component configured to receive the user data and analyse the user data based on a pre-determined analysis, the analysis component is further configured to output in-formation based on the analysis; a recommendation component configured to received the output information and generate one or more recommendations based on the output information; and an execution component configured to received the one or more recommendations and automatically update a schedule of the one or more groups based on the one or more recommendations.

### BRIEF DESCRIPTION OF DRAWINGS

Further features and advantages of the present disclosure will become apparent from the following detailed description, taken in combination with the appended drawings, in which:

FIG. 1 depicts a data flow for a hierarchy system;

FIG. 2 depicts an architecture of the hierarchy system;

FIG. 3 depicts the data sources for performance measurement of an agent suite system;

FIG. 4 depicts a user interface showing a performance view where processed data is presented;

FIG. 5A depicts a flow of data and information for performance management of the agent suite system;

FIG. 5B depicts a flow of data and information for a feedback aspect of the performance management;

FIG. 6 depicts a flow of data and information for a compensation module;

FIG. 7 depicts a user interface showing incentive and compensation results view for an employee;

FIG. 8 depicts a flow of data and information for creating a communication within the agent suite system;

FIG. 9 depicts a flow of data and information for generating a report within the agent suite system;

FIG. 10A depicts an architecture of a budget tool;

FIG. 10B depicts the flow of data for the budget tool;

FIG. 11 depicts a flow of information from different groups for the budget tool;

FIG. 12 depicts a flow chart of the input and evaluation of known future influences (KFIs) in the budget tool;

FIG. 13 depicts an example of a user interface of the budget tool;

FIG. 14A depicts a flow chart for using a metric or KFI to modify a budget plan;

FIG. 14B depicts a flow chart for creating versions or iterations of a budget plan;

FIG. 15 depicts a flow chart for creating and exporting a report using the budget tool;

FIG. 16A depicts a method performed by a workforce management (WFM) tool or system;

FIG. 16B depicts a flow of data and information for creating a plan in the WFM tool;

FIG. 17 depicts a flow chart for a demand analysis, forecast workload, and demand plan in the WFM tool;

FIG. 18 depicts a flow chart for a capacity analysis, staffing calculation, and capacity plan in the WFM tool;

FIG. 19 depicts a flow chart for a hiring analysis, hiring requirements, and hiring plan in the WFM tool;

FIG. 20 depicts a flow chart for a placement and conditions analysis, integration of the demand and capacity plans, and placement plan in the WFM tool;

FIG. 21A depicts an architecture of a queue monitor system;

FIG. 21B depicts a flow of data for the queue monitor system;

FIG. 22A depicts a user interface showing a back office view for the user in the queue monitor system;

FIG. 22B depicts a user interface showing a robotic process automation (RPA) view for the user in the queue monitor system;

FIG. 22C depicts a user interface showing an eChat view for the user in the queue monitor system;

FIG. 22D depicts a user interface showing a front line queue statistics view for the user in the queue monitor system;

FIG. 22E depicts a user interface showing historical and automated reporting for the front line queue statistics in the queue monitor system;

FIG. 23 depicts a method of creating an alert or report at the alert management layer of the queue monitor system;

FIG. 24 depicts various frontline metrics available for the alerts;

FIG. 25 depicts an overview of a virtual manager system;

FIG. 26 depicts an embodiment of the functioning of the virtual management system;

FIG. 27 depicts an embodiment of the functioning of the virtual management system when a system issue is reported;

FIG. 28 depicts an embodiment of the functioning of the virtual management system for creating or generating an overtime request;

FIG. 29 depicts an embodiment of the functioning of the virtual management system for creating or generating a time off offer;

FIG. 30 depicts an embodiment of the functioning of the virtual management system for reporting lateness and absence;

FIG. 31 depicts an embodiment of the functioning of the virtual management system for offering, viewing and accepting shift trades;

FIG. 32 depicts an embodiment of the functioning of the virtual management system for determining a gap in business operations and recommended actions for workplace optimization;

FIG. 33 depicts an example of a user interface generated by the virtual management system;

FIG. 34 depicts a method of selecting a model for daily forecasting;

FIG. 35 depicts a representation of a workforce optimization system; and

FIG. 36 depicts a workforce optimization method.

### DETAILED DESCRIPTION

The present invention provides systems and methods for managing and optimizing the operations of a business/organization. The systems and methods comprise various workforce optimization tools/modules that are interconnected/interoperable to exchange data there-between and can thus provide holistic information for an organization that can be used for intelligent decision making with respect to optimizing the workforce of the organization. In addition to the various workforce optimization tools providing a breadth of information, each workforce optimization tool also provides a depth of information by capturing detailed information at a high-level of granularity. Accordingly, while embodiments of the present disclosure describe using data that has been efficiently and accurately collected from multiple tools to facilitate intelligent decision-making for workforce optimization, it will also be appreciated that each tool may be used individually to provide detailed information and functionality as described herein. The systems and methods described herein thus record, store, and update data about employees and groups in the business, and may be used to notify users and other tools/applications of various changes or updates, to communicate with users and other tools/applications, and to provide artificial intelligence functionality. For example, machine learning recommendations may be generated and provided by one or more of the systems to plan and create forecasts and to determine recommended actions for optimizing the workforce.

The systems and methods may comprise one or more of a hierarchy tool, agent suite tool, budget tool, workforce management (WFM) tool, and queue monitor tool. A virtual management tool is also described that interfaces with each of the hierarchy tool, agent suite tool, budget tool, workforce management (WFM) tool, and queue monitor tool to determine recommended actions for workforce optimization. Each of these tools are described below with reference to the drawings. It will be appreciated that the terms “tool” and “system” may be used interchangeably when describing the tools of the invention.

While the present disclosure describes particular implementations of these tools in the context of optimizing a call center workforce, it will be appreciated that the systems and methods disclosed herein may be implemented in other types of organizations/businesses.

### Hierarchy Tool

The hierarchy tool provides a method and system for capturing all possible human resource components within an organization which reside under a variety of different business structures or streams. The system allows all users such as managers to update the hierarchy changes within their team, such as employees going on leave, resignations, lateral movements, movements into outside departments and more, quickly within this system. This system draws on Customer Relation Management (CRM)-based systems to retrieve and store existing team attributes, such as which business segmentation an employee belongs to, their hiring date, and their chain of command up to high levels of management.

The hierarchy system stores and updates information on employees comprising employee details, location details, employee status, segment information, hierarchy information, and system IDs. The employee details comprise a hire date, name and email of the employee, unique employee number, and the employee's work from home status identifying if the employee works from home any days. The locations details comprise company names and locations where the employee works. The employment status comprises a current active or inactive status of employment, the employment type, and may be used to identify if the employee is on long-term leave or short-term leave. The segment information comprises a business domain hierarchy to identify where the employee belongs to in the larger organization, Line of Business (LOB)/segment, and skill types. The hierarchy information comprises report to structure leading up to the executive team along with their levels in the organization. It will be appreciated that report to structure is the hierarchy of management describing who reports to who from base employees to high up management. The system IDs comprise all system IDs that belong to the employee.

Keeping up-to-date on all of the above information of an employee can be challenging when there are multiple source systems in place. The hierarchy tools allows all of the relevant systems to be updated based on updates in the relevant systems. This allows for constant and accurate reporting of results, planning and forecasting resources and for strategic decisions to be made about which teams to expand and grow. For example, employees may have unique system IDs that allow for the recordation and storage of the employee's interactions within a billing system, and of the employee's results and performances from various computerized management systems. The information is stored for each employee so that the data can be aggregated and displayed in, for example, a performance management application.

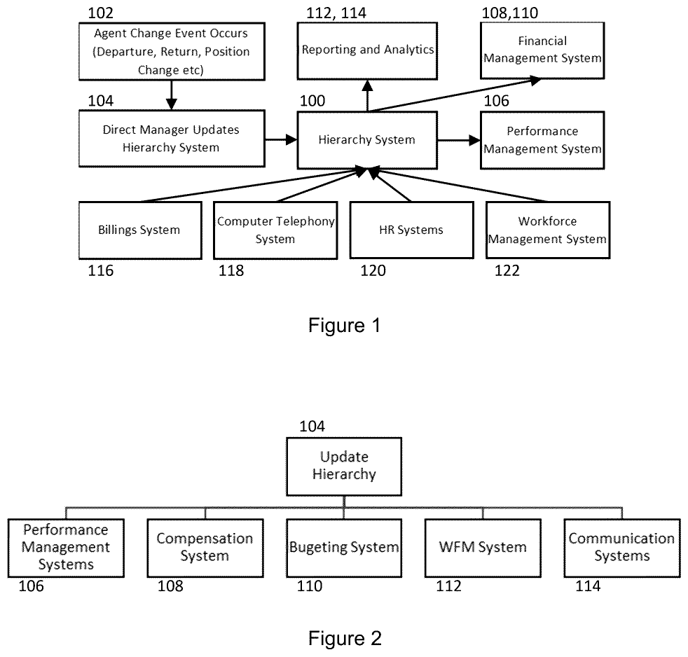

FIG. 1 depicts a data flow for the hierarchy system 100. FIG. 2 depicts an architecture of the hierarchy system. The hierarchy system may be used to update and keep track of all employees. For example, call centre operations may have many employees that transition in, within, and out of various teams within the business. The hierarchy system 100 allows for any changes in employment to be captured and updated.

When a change in hierarchy occurs (102), such as a new employee is hired or an employee leaves, a user, such as a direct manager, can update the system (104). Other updates may include movement within the group, such as promotions, going on leave, resignations, lateral movements, and movements into outside departments. The hierarchy system 100 then automatically updates the relevant systems based on the update by the user. Such systems comprise performance management systems 106, compensation systems 108, budgeting systems 110, workforce management (WFM) systems 112, and communication systems 114.

This automatic update allows for information stored and used to analyze the employee in the systems to be accurate and up-to-date. For example, as described below regarding the virtual management system, when offering overtime, a user would not want the overtime to be offered to an employee who has just recently gone on leave.

The hierarchy system may be used to update the various tools described herein, or other business tools. The systems and tools described herein may also update the information stored in the hierarchy system. For example, the hierarchy system 100 may retrieve or collect data from billings systems 116, computer telephony systems 118, HR systems 120, and workforce management systems 112.

### Agent Suite Tool

The agent suite system is a management system for monitoring and measuring the performance of employees. For example, the system may be used to monitor and measure interactions by call centre agents over multiple telephony platforms. The system can be used with other tools described herein, such as the hierarchy tool described above to obtain information on various employees and groups, such as the group to which they belong and their title within the group, and the budget tool described below to analyse spending and compensation for various groups and plan for future spending and compensation.

The agent suite system provides a scheduling module which provides users with their schedule, and provides leaders with their group's schedules. This allows users to view schedules, leaders to post additional hour offers, or other work shift offers that a user may accept. Users can accept these offers within the system, and upon acceptance, their schedule is updated immediately. The scheduling features of the system further allow users to create shift trade requests that may be transmitted to specific users, or to any user that may desire the additional hours. The scheduling module includes viewing and may be connected with the virtual manager system further described below.

The system further allows leaders to record and view particular users absences through a presence at work module which is connected to scheduling module and updates the particular user's schedule based on the absence report.

The agent suite system provides for performance measurement, performance management, compensation, communication, and reporting and analytics. In connection with the other tools described herein, the agent suite system allows for a full view of an individual's or a group's performance including financial considerations. These performances are determined based on pre-defined, user-defined, or budget-based targets for various metrics. The targets may be set by users for themselves, or for their employees. These targets may be set based on various business requirements. For example, a business may estimate a certain sales target, and create assumptions and plans for achieving the desired number. The business may then create smaller targets for each business segment and combinations of the targets. These targets may be modifiable by responsible users within the system.

The targets may be set for particular groups to increase the performance of a group during particular periods or overall. Targets for specific groups may be set and changed within the system. Targets specific to particular employees, such as new employees may also be set. The different target types allow for the modules of the system to be connected. For example, budget-based targets allow for the performance and compensation modules to be connected. This allows for the performance metrics to be shown and compared with spending metrics.

Users, such as compensation managers who create compensation plans, may use the system to set targets to create customer compensation plans based on a targeted business group. The user may set the base pay rate and target teams to be included as part of the compensation strategy. The user can also set commissions and bonuses for each individual product sold for the particular team, within the compensation module of the system.

As described below, the report and analytics module of the system allows for multiple metrics to be presented in reports. It will be appreciated that a percentage-based system may also be used to give weight to each of the metrics. This allows for a priority for each business group to be determined. The performance management module and the reporting and analytics module allows for a user to view different levels of results, for example how many agents have received a designated coaching from their leader and which team is performing better in view of coaching efforts.

The agent suite system allows for an accurate measurement of performance across multiple geo-locations, telephony systems, and CRM systems to produce consistent, reliable company-wide results.

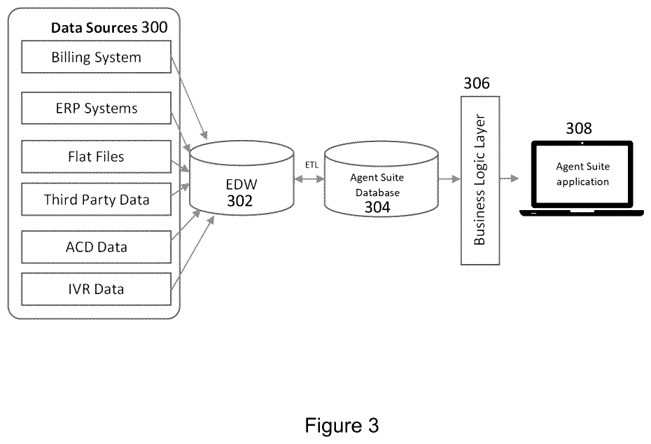

FIG. 3 depicts the data sources for the performance measurement of the agent suite system. The performance data sources 300 are connected in a server environment and capture all relevant data allowing the system to produce a comprehensive view of the data within the environment. As there is business logic alignment for the data displayed it may be considered as a ‘single source of truth’ allowing multiple organizations to take advantage of it.

The data includes data from billing systems, enterprise resource planning (ERP) systems, flat files, third party data, Automated Call distribution (ACD) data, and Interactive Voice Response System (IVR) data. This data may be transmitted to and stored in an Enterprise Data warehouse (EDW) 302 from multiple sources such as telephony systems, contact centre unified communication systems, routing systems, and customer relationship management systems. The data is transformed from the EDW 302 into one or more Agent Suite databases 304 through an Extract, Transform and Loading (ETL) process. The data may then be processed through a layer of business logic 306 for metrics calculations to be presented within Agent Suite applications 308 in various modules.

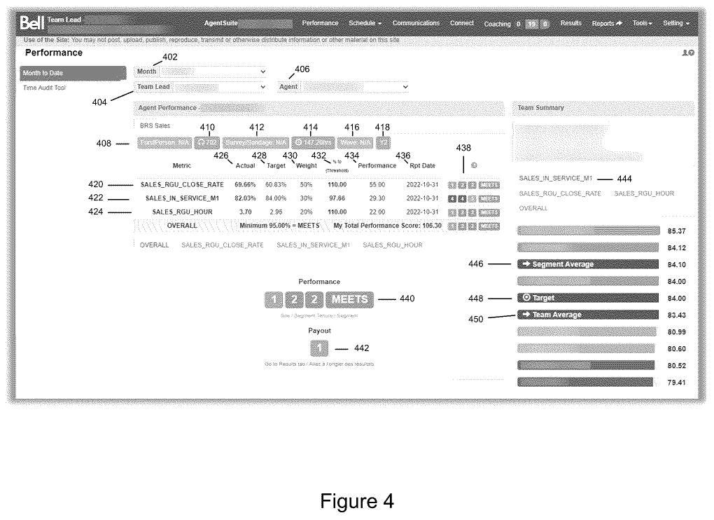

FIG. 4 depicts a user interface showing a performance view where the processed data is presented. A user may select the month (402) for the results and data to be shown, the team leader (404) or other similar identification for the employee's results, and the particular employee or agent (406) whose data is being presented.

The performance view may also depict an entrance score for the agent to determine their Sales and Loyalty potential (408), a number of contact the employee had for the selected month (410), survey results for the employee (412), working hours for the employee (414), an employee initial training cohort number (416), the employee tenure within company (418), sales metric used for the employee's scorecard (420)-(424), the actual results for the selected month (426), a metric specific target for the employee (428), a percent weight for each metric to total 100% (430), a resulting percent to target performance based on actual vs. target for employee scored (432), performance score based on the percent to target result (434), the last reported result date (436), quartile results based on site, segment tenure and segment and whether the employee meets or doesn't meet criteria (438), overall score based on three levels (site, segment tenure and segment) which identify top performers at different levels (440), payout level quartiling which is used for compensation bonus calculation (442), summary of metric results for the individual and their team (444), segment average for the same team for that metric (446), target which is set by performance experts (448), and team average for that metric (450).

The agent suite system further allows for performance management such that supervisors or managers may create coaching records to improve performance of their employees. Users can evaluate agent performance and conduct appropriate coaching and training discussions with the respective employee to improve their performance. This is achieved by capturing the results, before and after such discussions and assigning appropriate training to individuals.

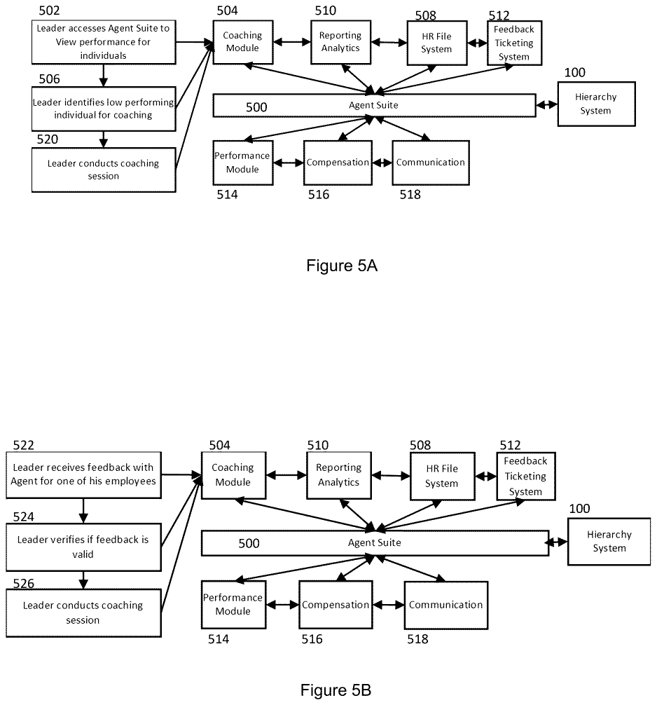

FIG. 5A depicts a flow of data and information for performance management of the agent suite system. A user, such as a leader (supervisor or manager) may access the agent suite system 500 to view performance metrics and data for various employees or individuals (502). The performance metrics and data for training and coaching may be accessed via a coaching module 504 of the system 500. If there is a low performing individual, the user may identify the individual within the coaching module 504 of the system for additional training or coaching (506). The individual may be identified based on low performance data or in some cases, based on their title and ranking within the company for new or additional training. The title and ranking of the individual may be retrieved from HR file systems 508 or the hierarchy system 100 to allow the user to determine which individuals may need training or coaching. The user may select a particular type of training for the individual via the coaching module 504, such as performance based training, attendance based training, or disciplinary based training. Once the system receives the selected training, questions may automatically be presented to the user for additional information on the type of training desired and/or the identified individual. The system 500 may generate a performance record for the identified individual to store the information input and update the information stores based on the training and other data within the system. It will be appreciated that the agent suite system 500 collects data from and transmits data to the hierarchy system 100, coaching module 504, reporting and analytics systems 510, HR file systems 508, feedback ticketing systems 512, performance module 514, compensation systems 516, and communication systems 518 to ensure the individual's and the company's data is up to date for any future decisions on staffing, finances, and more.

Once the individual is provided the training or coaching by the user or other employee (520), the agent suite system 500 updates the identified individual's status and determine next steps for the individual based on the information received from the user and based on data stored within one or more systems and databases in the system 500 about the identified individual. The next steps may include a next action for training for identified individual, or a warning or positive notice to be issued to the identified individual. The stored data may comprise attendance information, work hours, number of tasks or calls completed by the employee, results of the tasks or calls, and results of the training or coaching. The system may further generate a notification or letter to be presented to the individual regarding the determined next steps.

The system communicates with and may receive or transmit data to various sources of data such as the databases described above, which allows the system to track and store metrics and information about various employees. The user or leader may access the performance management data before and after various training and next steps have been determined and completed by the employees.

The types of training and the next steps determined by the stem may be based on pre-determined or pre-approved performance paths by the company. For example, the performance paths may be stored within the system as preprogrammed paths or may be created by users such as HR employees. The pre-determined or pre-approved paths may comprise paths for new employees, promoted employees, employees returning from leave, employees who have been transferred within the company, and paths based on results of previous training or training already completed by the employee.

The performance management of the system may further allow leaders to set thresholds for low performance on any metric they choose. This allows the system to automatically notify and flag employees who do not meet the set threshold. This allows the system to compile and present any employees who have or have not met the set threshold to leaders. The system may further automatically assign a leader to a particular employee, based on the threshold, for additional training.

The agent suite system further allows other users, who are not necessarily leaders, to provide feedback for identified employees or individuals. FIG. 5B depicts a flow of data and information for the feedback aspect of the performance management.

The agent suite system 500 may determine a user to provide feedback for a particular employee or another user may identify a user to provide the feedback. The user may be determined based on their work relation with the identified employee. In such a case, the system generates a ticket for the user based on the determination or identification, along with the category or type of feedback requested. For example, the feedback may be requested based on low attendance, low performance metrics, or other reasons. A notification may then be sent to the user to identify that their feedback is requested. Once the user provides the requested feedback, or provides feedback without being requested, the feedback may be sent to another user, such as a leader, to approve the feedback provided based on, for example, established Standard Operating Procedures (SOPs) (522). The other user verifies if the feedback is valid (524) and can create a coaching session, such as the training identified above, for the identified employee based on the feedback (526). The verification and coaching sessions may be input and processed via the coaching module of the agent suite system 500. In some embodiments, the verified feedback may be sent to the employee for display and future discussions. Upon receipt of an indication that the coaching session has been completed or a discussion has been had, the agent suite system 500 automatically updates the various systems.

The agent suite system 500 further provides interconnected layers that can capture results, establish targets, create incentives and then execute payouts. For example, a user or leader can create a campaign for rewarding employees that achieve high results. The system may generate and present campaigns and targets based on pre-defined campaigns or targets, or based on new campaigns and targets that are set by the user.

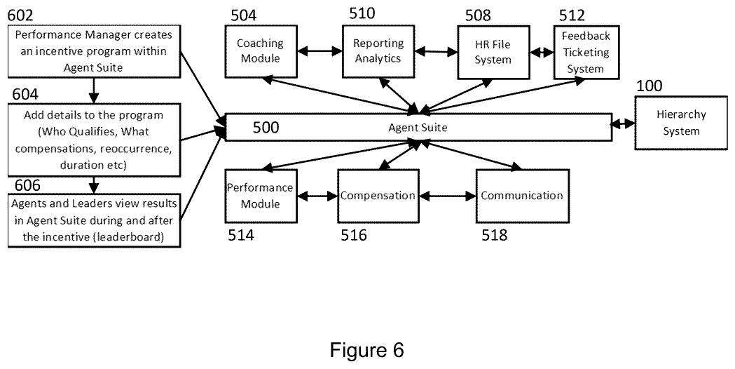

FIG. 6 depicts a flow of data and information for the compensation module. A user or performance manager may access the agent suite system 500 to create an incentive program (602). Once the system 500 receives an indication from a user for creating or generating an incentive program, the system 500 may automatically request additional information from the user about the incentive program, or the user can input additional information before any prompt from the system 500 (604). For example, the user can identify qualifiers such as a minimum number of tasks to be completed and an amount for each employee to be compensated. The system 500 may determine, based on the qualifiers, how many employees would qualify for and receive the incentive, and present such information and the cost associated with the information to the user. It will be appreciated that the determination is done using the information stored in the one or more databases or systems about the employees and their performance data. The user can determine if the incentive should be implemented based on this presented data, and how often the incentive should be activated. For example, the incentive may be activated every month, or other amount of time to encourage employees, or the incentive may only be active the initial time as a type of reward for employees. The system further sets the duration period of the tasks to be completed by the user to qualify for the inventive based on a period inputted by the user. Once the incentive has been generated and activated by the system, the system further automatically generates a notification or other notice to be transmitted and presented to all employees that qualify for the incentive to indicate the results of the incentive. The notification is presented to the employees and the results are stored within the system 500 for access by the employees and the user (606). Over the period of the incentive, the employees may view their task completion statuses and view a determination, by the system, of if they are close to or have already qualified for the incentive. The employees may also view the amount of compensation to be provided if they qualify for the inventive, based on their title, rank and other criteria.

It will be appreciated that the system may further transmit a notification about the incentive to all employees once the incentive has been generated and activated. The notification may further identify how an employee may qualify for the compensation.

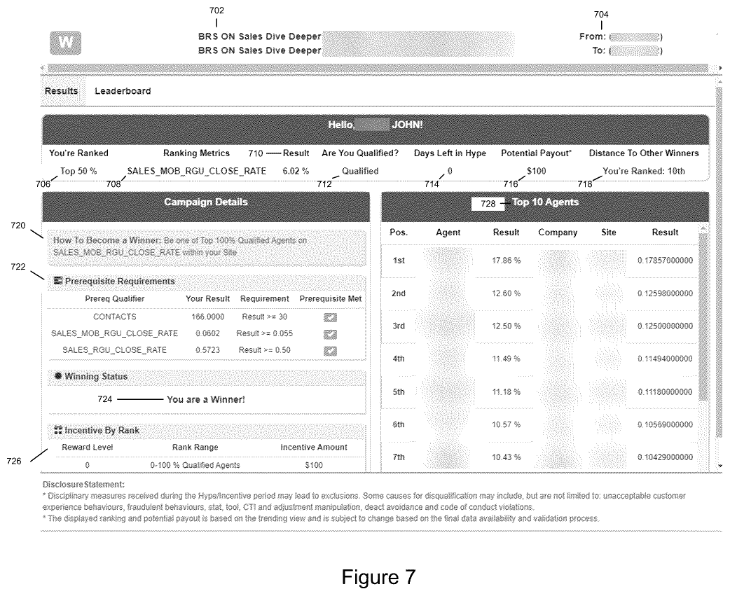

FIG. 7 depicts a user interface showing incentive and compensation results view for an employee. The name of the incentive (702) and duration of the incentive (704) may be displayed. The view also displays the ranking of the employee (706), the target metric for incentive (708), the employee's result (710), the number of days left for the incentive (714), the potential amount for the employee to be compensated (716), and the ranking for the employee compared to other employees (718). Details about the incentive such as the qualification details (720) and prerequisite requirements (722), for example, a minimum number of hours required for the incentive are displayed.

The employee may also access their status as to whether they have qualified or not (724), the wining award level depending on where the performance landed for the employee (726), and a list of the top qualifying employees (728).

The agent suite system further allows for communication between users and for reports and analytics to be generated for users. The system allows for leaders to communicate with their employees in a timely fashion to, for example, communicate time-sensitive information. Outage-related details, promotions, incentives and other pertinent information may be communicated quickly to employees through the system. Some employees may have personal telephone contact information along with work contact information stored in the system. This allows certain communications to be transmitted directly to a user's personal contact information.

Reports and analytics may be generated and presented to users dependent on and based on the user's title and rank. For example, a direct leader can receive and view their specific results, and a performance expert may receive and view sales-related metrics, such as number of products sold, from a variety of sales teams that operate within the company. This allows the user review performances, and set strategies or next steps for the group and/or company.

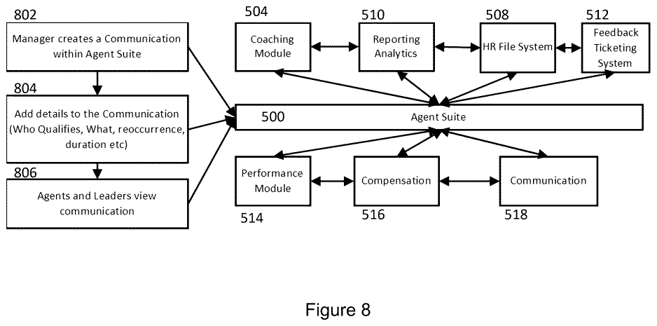

FIG. 8 depicts a flow of data and information for creating a communication within the system. A user or manager can access the agent suite system 500 to create a communication (802). The system 500 receives the request to create or generate a communication from the user, and may also request or receive an identification of the target audience for the communication to be transmitted to and other information for the communication (804). The user can provide the communication, the date of the communication to be transmitted, and identify if the communication is critical or non-critical. Any communications identified as non-critical may be skipped by the employee that the communication is transmitted to, whereas a critical communication may be presented to the employee upon transmission and receipt by the employee. The system 500 then transmits the communication to the identified target audience (806) and records if the employees have or have not read the communication. The recordation may be transmitted to the user for review. It will be appreciated that the communication may be generated and transmitted via the communication systems of the agent suite system 500. Information regarding the communication, and which employees have viewed the communication may be stored within the system 500.

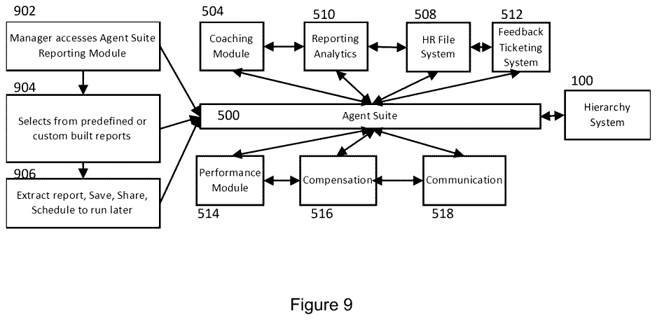

FIG. 9 depicts a flow of data and information for generating a report within the agent suite system 500. A user or manager may access a reporting module of the system 500 to generate a report (902). Once the system receives a request from a user to generate a report, the user may select from predefined reports or generate a new report (904). If the predefined report is selected, the system presents a list of reports to the user. The list may comprise operational metrics reports, coaching reports, communication reports and others. If the new report is selected, the system 500 requests information from the user, such as the metrics desired by the user for the report. The system receives the user's selection of the predefined report or of the desired metrics, a target audience that the results are to be based on, and a period for the results. The system 500 then generates the report which may be extracted, saved, shared, and scheduled to run at the time at a later time (906).

### Budget Tool

The budget tool provides a method and a system for financial planning. The budget tool uses aggregated data sources from various disparate sources to create a budget plan. The sources may include the databases described above and used with the hierarchy and agent suite tools. The budget tool allows for budget teams to create budgets that take various estimates of the business into consideration without requiring extensive spreadsheets and time. The budget team may make their own estimations for generating a first budget plan, and then they may update the budget plan based on various factors presented in the budget tool.

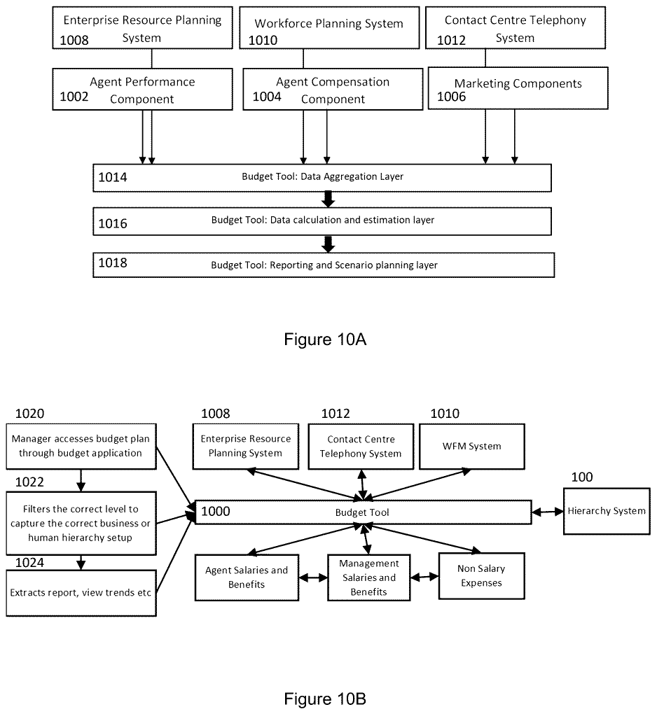

FIG. 10A depicts an architecture of the budget tool. To create a budget plan, the tool uses information or data about a user's performance 1002 and compensation 1004, and marketing data 1006. This data may be stored within and obtained from ERP systems 1008, workforce planning systems 1010 such as workforce management systems, and telephony systems 1012. The budget tool comprises a data aggregation layer 1014 for aggregating the information and data, a data calculation and estimation layer 1016 for performing various calculations on the data based on input estimations, and a reporting and scenario planning layer 1018 for generating reports and plans based on the calculations and estimations.

The relevant data is automatically retrieved from the systems based on the budget plan being created. This allows users to view all the relevant data without requiring several dozen spreadsheets. The data is then processed and budget estimates are made based on the processed data via the different budget tool layers.

FIG. 10B depicts the flow of data for the budget tool 1000. The budget tool 1000 may receive and transmit data and information with the ERP system 1008, telephony systems 1012, a workforce management system 1010, and the hierarchy system 100. The budget tool 1000 further communicates with employee and management salary and benefits storage systems, and non salary expense storage systems. A user or manager can access a budget plan that has been created using the budget tool 1000 (1020). While accessing the budget plan, the user can select various filters or restrictions to capture a particular business or hierarchy set up (1022). The user may also extract various reports and view trends in the market to update the budget plan (1024).

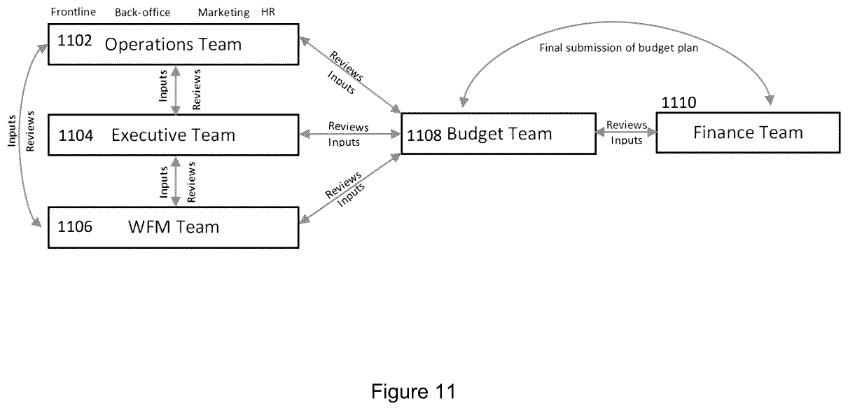

The budget tool allows for multiple teams and groups to provide input and review any budget estimations. For example, as depicted in FIG. 11, the operations 1102, executive 1104, and work force management 1106 teams can coordinate within the system to provide input and review various known future influences (KFIs) and the generated budget estimate. KFIs may be input by various groups such as the workforce management teams whose KFIs may be particular to scheduling and available employees, and the performance management teams whose KFIs may be particular to trainings that will provided and the cost of the trainings. The KFIs input by various groups allow the budget team to update any budget estimates. For example, if a group is going to run a sale or promotion on a particular item or service of the business, the group may input such an influence into the system. The budget team can view and analyse such KFIs to modify any budget estimations and calculations for particular time frames. In some cases, such KFIs may require additional employees to be staffed to continue providing quality service, which would require the budget to cover the salary for the additional workers. The budget estimate, once generated by the team and the tool is transmitted to the various teams, and then to the budget 1108 and finance 1110 teams for final input and review. Coordinating with multiple groups allows for multiple inputs to be considered for the budget plan. The KFIs may include strategic direction, expected performance efficiencies, productivity improvements, new hiring and staffing plans, costs associated with labour and non-salary expenses and others.

The budget team may specifically assign particular teams to review and provide input on the budget estimate, or on particular versions of the generated budget estimate.

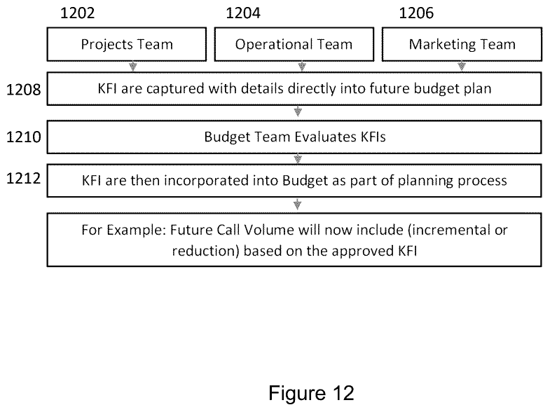

FIG. 12 depicts a flow chart of the input and evaluation of KFIs in the budget tool. Various teams such as a projects team 1202, an operational team 1204, and a marketing team 1206 may input one or more KFIs into the tool. The input may include details on how the KFI may affect the budget plan, and potential future budget plans (1208). The budget tool automatically receives these inputs and provides them to the budget team to evaluate and analyse (1210). For any KFIs approved by the budget team, the approved KFIs may be used to modify the budget plan by incorporating the various factors into the budget plan (1212).

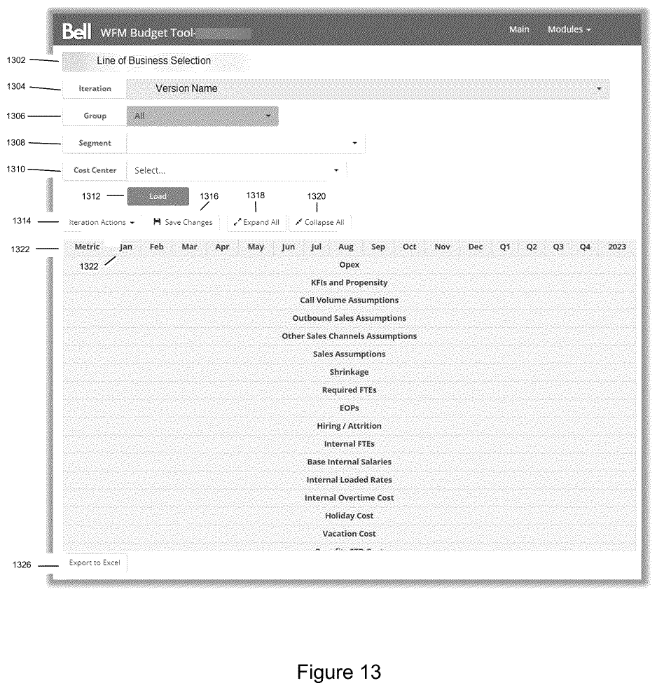

FIG. 13 depicts an example of a user interface of the budget tool. A user or member of the budget team can identify a line of business (1302) to view or create a budget scenario for, the group (1306) for the scenario such as the front-line, back-office, or projects team, the particular business segment (1308) within the group, and the cost centre (1310) which may unique to the group selected to register any costs. An iteration name (1304) may be input by the user for version control and management.

The user can further select the load (1312), allowing the user to view the selected business group and its financial planning details. The iteration actions (1314) allow the user to create extracts for additional insights and analytics. The iteration actions (1314) also allow the user to create different scenarios and make any changes that might be required. The budget scenario may be saved (1316), and the user can select to expand (1318) or collapse (1320) all of the subcategories displayed.

Each metric (1322) may be identified with each sub category, and the user can select to view monthly and quarterly projections for the budget (1324). The budget scenario may be exported (1326) to another program such as excel should the user desire to export it.

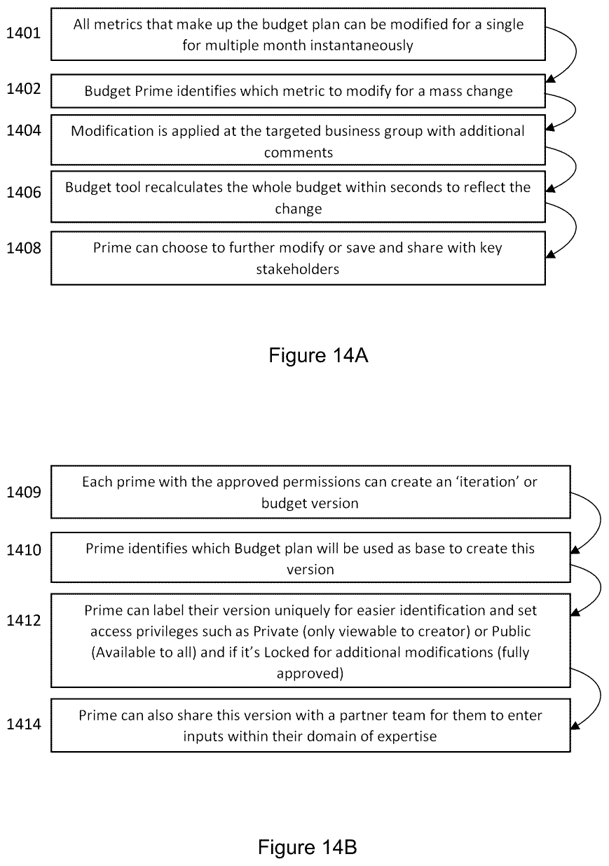

FIG. 14A depicts a flow chart for using a metric or KFI to modify the budget plan. It will be appreciated that any approved KFI can be used to modify one or more metrics that make up a budget plan. When one or more metrics are modified, the budget tool automatically updates the budget plan for the future months.

A user or budget team member may access the budget tool to modify one or more metrics of a budget plan (1401) for a set period of time (e.g. a month) or multiple set periods of time (e.g. multiple months). The user can identify the one or more metrics to be modified (1402). The budget tool then automatically applies the modification to the identified group to which the one or more metrics apply (1404). The complete budget plan is then immediately recalculated, by the budget tool, to account for the identified group's budget modifications (1406). The recalculated budget tool is presented to the user. The user can modify the budget plan based on their knowledge, or they may save and share the budget plan for approval by other users such as stakeholders (1408).

FIG. 14B depicts a flow chart for creating versions or iterations of a budget plan. A user or budget team member may decide to make versions or iterations of the budget plan based on potential KFIs and metric changes (1409). The potential KFIs may not yet be approved or may be estimations by the user. The user can identify which budget plan they will create versions or iterations for (1410). Using the method of FIG. 14A, the user can modify and save the versions iterations. The budget tool also allows the user to label each version or iteration and set access privileges such as private, public, or locked (1412). The versions and iterations can be shared with other users or teams for input and approval (1414).

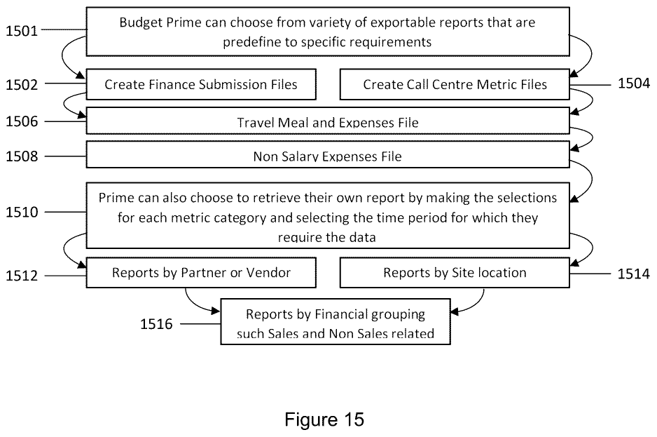

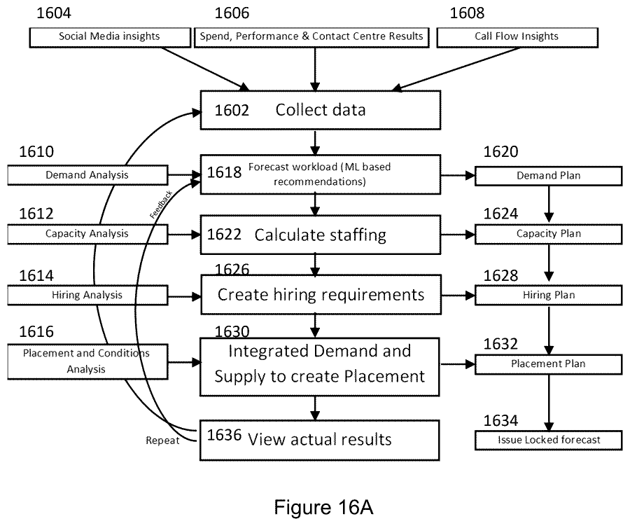

FIG. 15 depicts a flow chart for creating and exporting a report using the budget tool. The report may be predefined to have specific budget requirements (1501). The user can access the budget tool and create a finance submission file (1502) or an employee metric file (1504). They may further select from a travel meal and expenses file (1506) or a non salary expenses file (1508). If the user has a particular report they would like to create or export, they may select each metric for the report and apply particular time periods for the data used (1510). The reports may be by a partner or vendor (1512), by a site location (1514), or by the financial grouping (sales or non sales) (1516).

As described above, the budget tool can create, modify, and share budget plans. Users, such as budget team members, can generate the plans and cause the budget tool to share the plans to other users for input and approval. The budget tool also retrieves and stores data from various systems and KFIs input by different teams and users. The budget tool can link directly to enterprise resource planning applications, for example SAP and workforce planning and scheduling applications, and related user performance components.

### Workforce Management (WFM) Planning and Forecasting Tool

The WFM tool provides a method and process of creating and executing a forecasting plan. The plan may be created and shared within the tool and to other tools within the workforce optimization system (e.g. the budgeting tool described above). The WFM tool utilizes machine learning models to conduct demand analysis. A variety of time series models may be used for forecasting, such as Seasonal Auto Regressive Integrated Moving Average (SARIMA), Multivariable, Hybrid, Adjusted SARIMA, etc., and different forecasting techniques within models may be used (e.g. linear regression, auto-regression, seasonal auto-regression, neural network based methods, etc.). It will be appreciated that various forecasting models as well as techniques within forecasting models may be used for comparison to determine the best model and forecasting technique, as described in more detail below.

The models provide statistical time-series techniques that when combined with machine learning outcomes provide a more accurate forecast. The WFM tool may compare different models and apply trends from various different historical data points, resulting in numerous algorithms that support a forecast. In some embodiments, the WFM tool may compare over two dozen different models and a plurality of different trend data. The tool evaluates and recommends the best option and allows the user to use the forecast as-is, or to modify the forecast as needed to accommodate additional insights that a user may have.

The WFM tool uses aggregated sources of data to obtain all the relevant data for the user and the forecasting plan being created. This allows the user to compare and analyse the recent data and any historical data for the particular group for the plan.

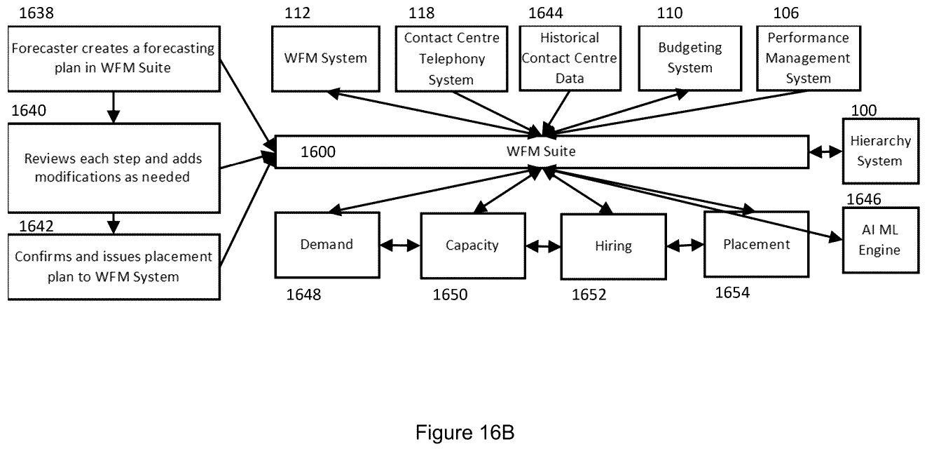

FIG. 16A depicts an overview of the WFM tool. The tool collects data (1602) from for example, social media insights (1604), spend, performance, and business results (1606), and call flow insights (1608). The social media insights 1604 may be particular to trends in the relevant field, and may be searched by the user to determine trends based on key words and how often key words were searched by different geolocations and regions. The spending, performance, and business results 1606 comprise all of the relevant data points that are available within the system. For example, the relevant data comprises results from the automatic call distributor (ACD) telephony platform, performance data from the agent suite tool, and budget-based targets from the budget tool. The combination of data provides the user a complete set of relevant and available data to base the forecasting plan. The call flow insights 1608 comprise information from applications that track flow and direction of the voice interaction of calls at call centres. This data allows the user to use historical data for call reasoning to better understand any growing or declining trends. It will be appreciated that although call centre businesses and trends are described, other businesses and trends may be used to forecast plans.

The data collected (1602) may be collected over a particular period of time, and may be collected daily, monthly, weekly, quarterly or yearly. The collected data is analysed based on the type of data. Data relating to the demand of the services offered is analysed (1610), for example, the calls offered actuals, current handle times and resulting service conditions. Data relating to capacity of groups including partner groups is analysed (1612), for example performance, existing tenure mix, current shrinkage, absenteeism, occupancy, and more. Data relating to hiring is analysed (1614), for example the performance and cost of each group and partner groups. Data relating to placement and conditions is analysed (1616), this data includes existing combinations of demand and supply by the groups such that new different combinations may be made to view resulting expected conditions. The placement and condition data may comprise results, such as the forecast, from the demand and capacity analyses for the analysis.

The machine learning models are used to produce a number of time series-based forecasting models that the user can review and select from (1618). The machine learning recommended forecasting model with the highest probability is also identified for the user. Users may modify or update the data based on known or created known future influences (KFIs), which allows the forecasting models to be updated. The WFM tool can adjust and learn from the updated data to improve accuracy for future models.

Once all of the models have been updated and presented, and the recommended forecasting model identified, the user may select the forecasting model to create a plan based on the demand data (1620).

The tool uses the analysed capacity data to generate or create a staffing requirement based on the current and future capacity of the groups (1622). A capacity plan (1624) is then generated based on the output of the capacity analysis. The capacity plan provides a breakdown of capacity requirements for each group, and for example, for each segment, language, and site level. This plan may be used to feed the subsequent hiring projections.

The hiring analysis is used to generate or create hiring requirements for one or more groups (1626). The hiring requirement may be for a particular segment or a particular class. If a hiring requirement is generated for a group, the tool notifies the group to initiate hiring discussions and to fulfilling the request. A hiring plan (1628) is then created identifying a combination of all the hiring for the particular group.

The placement and conditions analysis allows for an integration of the demand and capacity plans (1630). The integration of the plans allows for a placement plan (1632) to be generated which may be sent to particular users such as stakeholders.

The plans are then combined to create a locked forecast (1634) which may be sent out to leader of groups for both long term and short term plans.

The tool also captures ongoing new results (1636) so that any adjustments can be made at the 90, 60 or 30 day mark before the forecasted month starts. The tool automatically captures the new results or new actuals on a regular basis, such as a daily basis. This data is automatically fed into the tool. The data continues to be captured and collected before, during, and after the plans are created and finalized. For example, if the plan is created 45 days before the forecasted month, the data is still collected and captured even after the locked plan is created. It will be appreciated that this may not automatically influence the forecasted plan, in particular, if the forecasted plan is already locked and issued to the leaders. The tool also allows the primes or personnel dedicated to the task to flag exceptions days with the reasons to identify for example, a huge spike in volume, so that it can be ignored or utilized in the future fore-cast. This flagging system is also unique and is designed to improve forecast accuracy.

FIG. 16B depicts a flow of data and information for creating a plan in the WFM tool 1600. A user or forecaster may access the tool 1600 to create a forecasting plan (1638). Once the tool 1600 receives a request for a forecasting plan from the user, the tool 1600 presents various steps and parts of the plan for the user to review, select from and modify as needed for the desired forecast plan (1640). Once the selections and modification have been confirmed, the tool 1600 issues the placement plan (1642).

The WFM tool 1600 may receive and transmit data and information with a WFM system 112, telephony systems 118, historical data storage 1644, budgeting systems 110, performance management systems 106, the hierarchy system 100, and AI machine learning engines 1646. The WFM tool 1600 further communicates with the demand (1648), capacity (1650), hiring (1652), and placement systems and groups (1654).

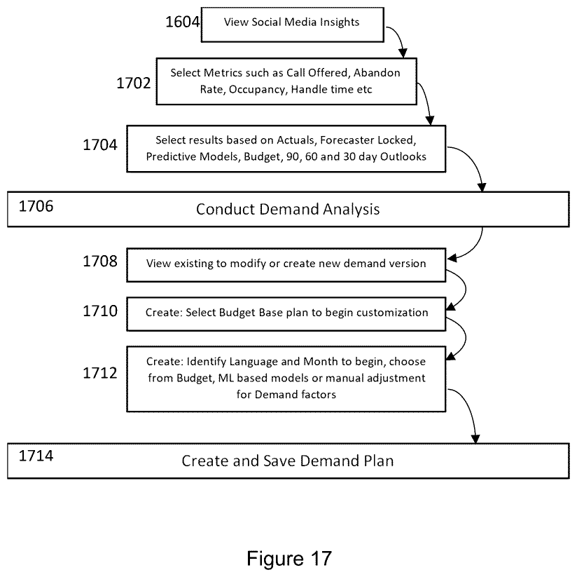

FIG. 17 depicts a flow chart for the demand analysis (1610), forecast workload (1618), and demand plan (1620). The user can view social media insights (1604), and they can select relevant metrics (1702) for the forecast from tasks completed, such as call offered, abandon rate, handle time, and more, and select relevant results (1704) for the forecast such as previous forecast plans, budget results, outlooks, and more. Once the system receives the selections, the demand analysis is conducted (1706), and a variety of machine learning predictive forecasting models are presented to the user for selection. The user may use the values/models as is or make additional modifications based on previous plans and on any additional KFI they are aware of (1708). Each model can be stored and retrieved later for additional modifications. Once the final model is selected by the user, a budget base plan may be selected (1710), and the language, month and other factors may also be selected for the demand forecast plan (1712). The demand plan is then created and generated based on the user's selections and the machine learning model selected. The demand plan can be stored within the system for retrieval and use later on (1714). It will be appreciated that the plan may be viewed as a calendar or similar system showing the monthly level forecast or a daily level forecast. This view allows for the expected volume of work for each day to be viewed by the user, allowing for the user to identify any trends or modify the plan from what has been generated. The system further allows the user to select from recent trend factors, such as over the last 4 weeks, 6 weeks, 8 weeks, or other, to capture recent trends with more weight for the forecast plan.

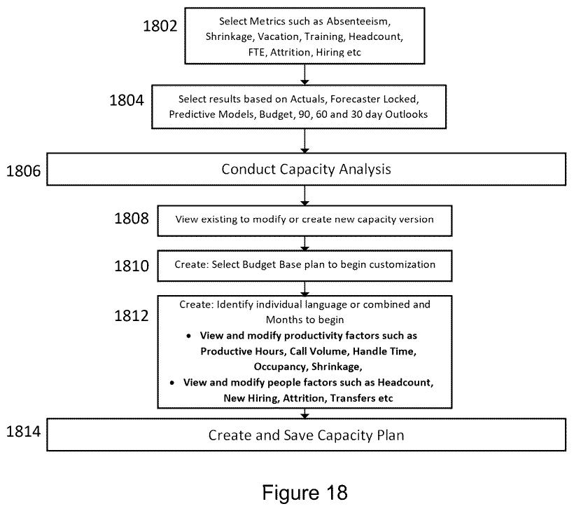

FIG. 18 depicts a flow chart for the capacity analysis (1612), the staffing calculation (1622), and the capacity plan (1624). The user may select relevant metrics for the capacity analysis for the forecast (1802), such as absence, shrinkage, vacation, training, and more, and select relevant results (1804) for the forecast such as previous forecast plans, budget results, outlooks, and more. Once the system receives the selections, the capacity analysis is conducted (1806), and capacity requirements are presented to the user. It will be appreciated that the capacity requirements may indicate the number of employees ready and available each day for various tasks, such as calling customers or answering customer's calls. The requirements may be set by the group leaders to for example a vendor to indicate how many hours of work is expected. The user or forecaster may use the values/requirements as is or make additional modifications based on previous plans and on any additional KFI they are aware of (1808). Once the final capacity version or requirement is selected by the user, a budget base plan may be selected (1810), and the language, month and other factors may also be selected for the capacity forecast plan (1812). The user may also view and modify certain metrics or factors before the plan is generated such as productivity factors and/or people factors. These factors may include productive hours, call volume, handle time, occupancy, shrinkage, headcount, new hiring, transfers, and more. The capacity plan is then created and generated based on the user's selections. The capacity plan can be stored within the system for retrieval and use later on (1814).

The capacity plan may be created such that it matches the previously determined demand conditions, as the generation of the plan considers factors that influence resourcing, such as shrinkage, hiring and attrition. The system also allows the user to view the productivity factors to determine how many staff or employees may be regarding to achieve certain results. The capacity plan allows for the user to determine when certain employees should be working, and with which groups. For example, for call centres, the plan identifies where calls should be placed, after a forecasting workload is created.

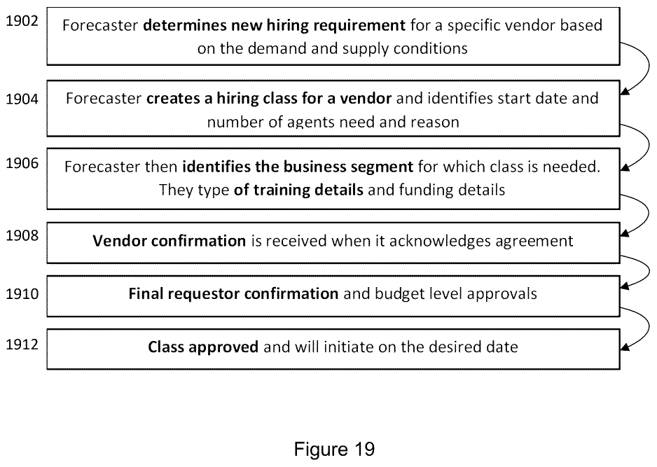

FIG. 19 depicts a flow chart for the hiring analysis (1614), the hiring requirements (1626), and hiring plan (1628). The user may view the hiring analysis (1614) and the demand and capacity plans generated to determine and create a new hiring requirement (1902). The hiring class, start date, number of employees to hire, and reason for the requirement may be provided by the user based on the analysis (1904), which is then sent to the particular group for the hiring requirement. The user can further identify the business segment for the hiring class and any particular training details and compensation details (1906). The system transmits all the hiring requirement information as a hiring plan (1628) to the particular group. Once the receiver acknowledges and agrees with the plan, a confirmation is sent to the user (1908). The system then sends the hiring plan for a final approval and for budget approvals (1910). The system receives the final approvals and the hiring plan is in place with the specified hiring dates (1912).

The tool allows for the hiring plan to be transmitted to many different teams, such as a vendor, budget team, and training team, at various stages of the approval process. The process is performed within the system. This allows for accurate tracking of each new hire class as well as the performances of the new hires using for example, the agent suite tool. The budget tool can be further used to determine if the budget for the new hires is possible or whether the vendor will cover the cost, based on the cost for the training activities. The system may store information regarding each vendor or partner group to determine if there is an agreement for cost already in place.

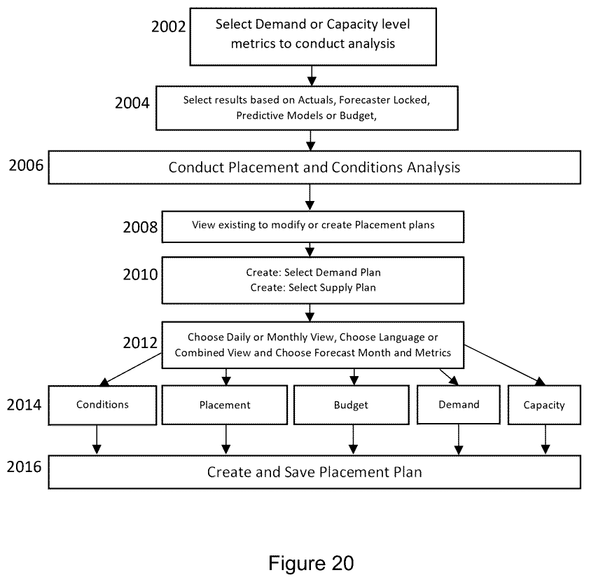

FIG. 20 depicts a flow chart for the placement and conditions analysis (1616), integration of the demand and capacity plans (1630), and placement plan (1632). The user may select relevant demand or capacity level metrics for the analysis (2002), and select relevant results (2004) for the forecast such as previous forecast plans, budget results, predictive models, and more. Once the system receives the selections, the placement and conditions analysis is conducted (2006), and the integration, by the system, of the demand and capacity plans are presented to the user. The user may use the values/integration as is or make additional modifications based on previous plans and on any additional KFI they are aware of (2008). Once the final integration is selected by the user, the generated demand plan and a capacity plan used for the placement and condition analysis are retrieved (2010), and the language, daily or month view, metrics, and other factors may be selected for the placement plan (2012). The user may view all of the plans generated in the process (2014) to update or modify features of the plans for the placement plan. The placement plan is then created and generated based on the user's selections. The placement plan can be stored within the system for retrieval and use later on (2016). It will be appreciated that the placement plan is used to identify which location or site for each group will handle the workloads.

Any modifications made by the user when generating or creating the placement plan based on, for example, budgetary spend requirements, the system will automatically readjust all impacted segments with new targets. The system can further identify and present any gaps between the plan and budget so that user may modify the plan accordingly.

The forecasting plans generated by and within the WFM tool allow for a business to plan for the appropriate staffing for each segment of business, hours of operation management to match the demand, additional hiring, and increase in performance criteria. It will be appreciated that inaccurate forecasts may lead to underestimating a business' workload which may cause employee burnout, high turnover, and negatively influenced service conditions. Similarly, overestimating the workload may lead to overstaffing and overspending. The WFM tool prevents any human errors due to data collection and calculations. It will be appreciated that any special days such as public holidays or special sales days such as Black Friday are may be treated differently within the data analysed as the data for these days may be identified as a special variable for modelling. The predictive models are able to identify these days and a special factor may be assigned to them that allows for special treatment during a model forecast. This ensures that high importance days are captured as such and allow for reasonable expected volume.

The WFM tool may incorporate the hierarchy, agent suite, and budget tools to accurately forecast plans for the business. This includes any vendors or partners used by the business. The incorporation of all the tools allows for accurate assumptions and allows for any changes for targets or other metrics to be recalculated and redistributed to all the relevant users. Machine learning based forecasting driven by the power of artificial intelligence allows for large amounts of data to be calculated and statistical techniques to be applied that would be humanly impossible to compute individually.

### Queue Monitor Tool

The queue monitor tool provides a system and method for users to monitor a state of operations during work hours. For example, it allows managers to view prevailing service conditions for a contact centre. The statistics of the operations may be viewed by interval for each business segment irrespective of their platform type. A high-level view as well as a more specific smaller level view may be possible for users. Users are able to view statistics immediately and take mitigation measures as necessary using other tools in the system.

The queue monitor tool may be used to automatically track occupancy (e.g. how many work-related actions items exist within a 15 minute interval) and place that as part of the overall occupancy for the individual employees under each category or work and aggregated to the overall team for a given time period (e.g. each month). This tracking is enabled by connecting the queue monitor tool to all systems where the support resources are performing their task. These support resources are required to support IT systems and their health and performance. Any time employees respond to a system generated trigger, support resources actions such as accessing the ticket, modifying or updating the systems, etc., are tracked and logged for each interval of their working schedule. This information plays an important role in understanding the resource availability and planning perspective and allows for monitoring how much work effort and time effort is required to complete each type of transaction.

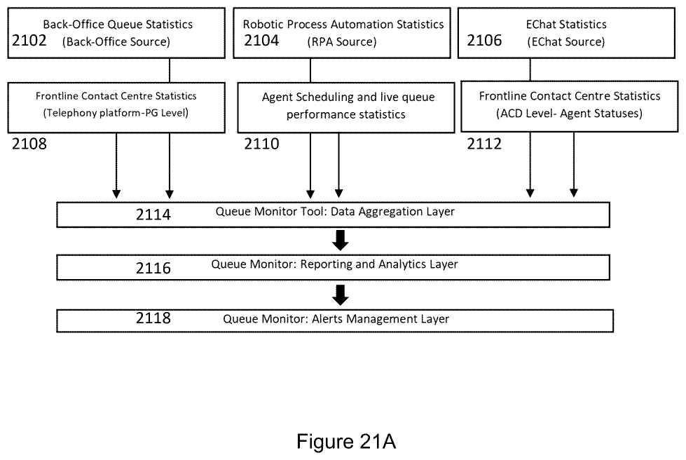

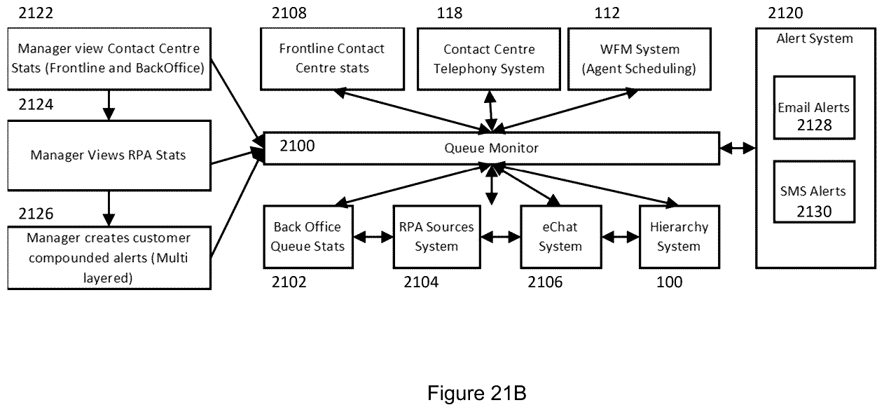

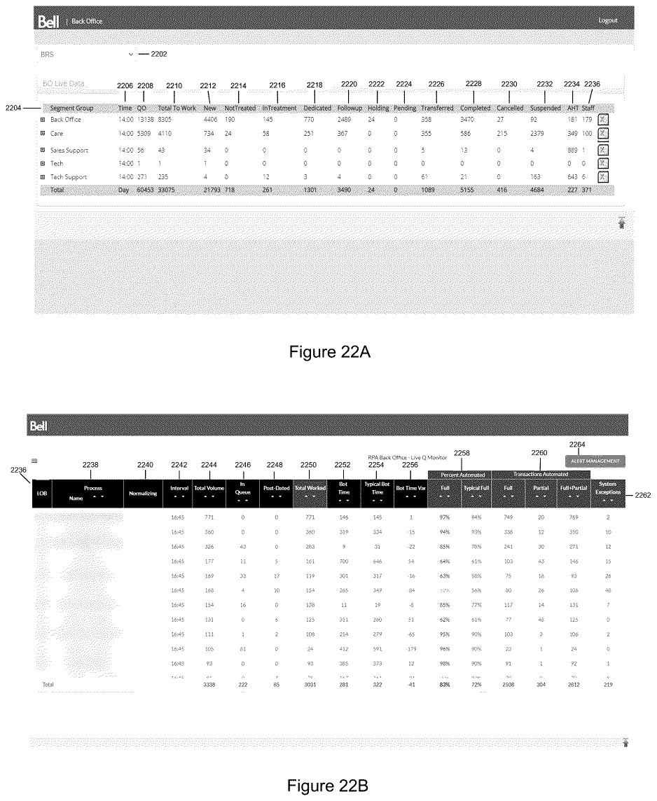

FIG. 21A depicts an overview of the queue monitor system. The queue monitor tool retrieves statistical data from various sources to present to a user. Data is sourced and aggregated from a back-office system (2102) and may be displayed. The data may relate to back office queues. Robotic processing times and completion rates are aggregated from a robotic process automation (RPA) system 2104. This information from the RPA system is displayed for a user at an aggregation layer 2214 so that the performance of any robots is quickly viewed to address any system issues or higher than normal failure rates. EChat related statistics are aggregated from eChat management systems (2106). These statistics relate to any chat features that may be used for aid from the business. The system can capture all chat-based real-time data and make it available for the aggregation layer 2114 to present to the user in real time without the user having to go through separate applications to get to eChat data. Segment level statistics from IVR, count of customers in queue, count of customer handled in a certain amount of time, and skills group type data is aggregated from a telephony source (Intelligent Contact Management (ICM) or Non-ICM based or any Contact Center as a Cloud CCaaS provider) (2108). It will be appreciated that, in embodiments where the business is a contact centre, the IVR allows customer call to be redirected based on the recorded dial tone response. Employee scheduling and live performance statistics are derived from scheduling software (2110) to show current staffing levels as well as live performances of employees. Employee level statuses for each employee segment coming are aggregated from an ACD system (2112), including, count of employees in particular modes of work.

A data aggregation layer 2114 of the queue monitor system combines all relevant data points into a holistic dashboard with separate sections for each service segment and channel type for a user's review. It will be appreciated that data from previous days may be retrieved and presented to the user within the same view. This allows for a quick assessment to identify if there is a growing trend in the pattern of volume or performance factors that are causing, for example, negative service conditions. A user does not need to pull reports on historical trends for performing the analysis.

A reporting and analytics layer 2116 of the queue monitor system allows for reporting views where graphical data for interval level statistics for each metric is displayed. Reports may be pre-composed by the system based on the data received to allow for quick view of the report. An alert management layer 2118 of the queue system provides a method for users to set up particular alerts and reports to be displayed or sent to them. The alerts are automated and may be set for any service related metric. The system will trigger a notification to be sent to the user as soon as a pre-set threshold is met for the metric. This allows users to have advance notice to address changing situations.

FIG. 21B depicts a flow of data for the queue monitor system 2100. The queue monitor system 2100 receives and transmits data and information with the frontline statistics 2108, telephony systems 118, WFM systems 112, back office sources 2102, RPA source systems 2104, eChat sources 2106, the hierarchy system 100, and an alert system 2120. A user or manager can view the frontline and back office systems when accessing the queue monitor system 2100 (2122). They may also view the RPA statistics from the RPA sources systems (2124). Once they have viewed and analysed the data and information, they may, via the alert management layer 2118 and alert system 2120, which may manage email alerts 2128 and SMS alerts 2130, set up alerts and/or reports to be displayed or sent (2126). It will be appreciated that these alerts and reports maybe compounded or multilayered. The alerts and reports may be sent and displayed using email and/or SMS systems.

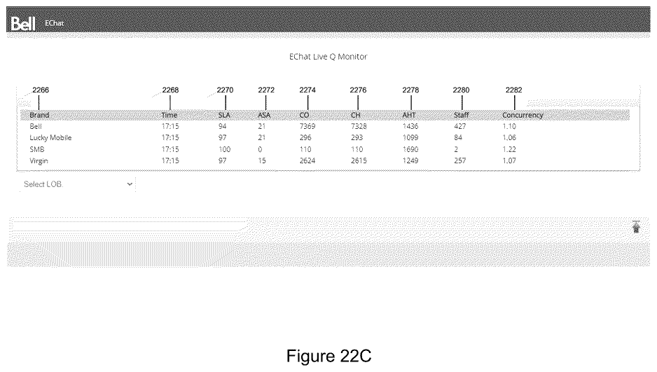

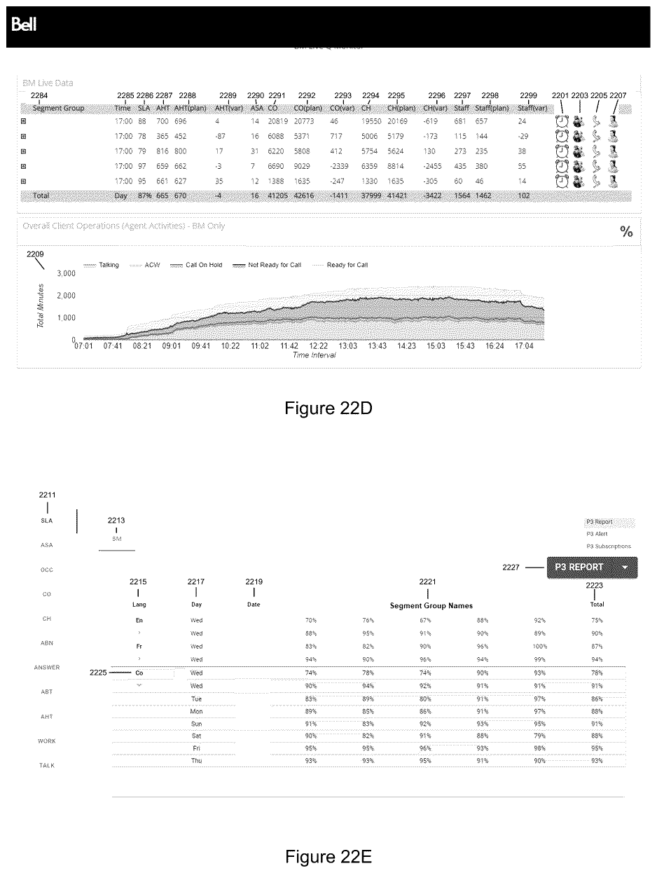

FIG. 22A depicts a user interface showing a back office view for the user. The user may select a Line of Business (2202) to view, segment groups and segments within them (2204). The view depicts a last reported time (2206), count of total tickets in inventory (2208), total count of workable tickets in the system (2210), number of new tickets inventory (2212), number of tickets not treated in inventory (2214), number of tickets in interlacement status (2216), number of tickets in dedicated status (2218), number of tickets in follow-up status (2220), number of tickets in holding status (2222), number of tickets in pending status (2224), number of tickets in transferred to another team status (2226), number of tickets in completed status (2228), number of tickets in cancelled status (2230), number of tickets in suspended status (2232), average handle time for tickets (2234), and number of staff currently active (2236).

FIG. 22B depicts a user interface showing a RPA view for the user. The RPA view depicts a line of business for the RPA process (2236), name of the process (2238), Identification if under normalization status (2240), last updated time interval (2242), total volume of RPA transactions (2244), number of transactions in queue (2246), number of post dated transactions (2248), number of total worked transactions (2250), time taken by robot to execute (2252), average time robot takes historically (2254), variance between current and historical time taken by robot (2256), percent of automated transactions (2258), count of transactions automated (Fully, Partially and combined) (2260), count of system exceptions (2262), and alert management system (2264).

FIG. 22C depicts a user interface showing an eChat view for the user. The eChat view depicts a line of business (2266), last reported interval (2268), service level (2270), average speed of answer (2272), contact offered (2274), contact handled (2276), average handle time (2278), number of staff online (2280), and rate of concurrency (2282).

FIG. 22D depicts a user interface showing a front line queue statistics view for the user. The front line queue statistics view depicts a business segment name (2284), last interval reported time (2285), service levels results (2286), average handle time actual (2287), average handle time plan (2288), Average Handle Time (AHT) variance (2289), average speed of answer (2290), calls offered (2291), calls offered plan (2292), calls offered variance (2293), calls handled actual (2294), call handled plan (2295), call handled variance (2296), staff present (2297), staff planned (2298), staff variance (2299), interval level breakdown (2201), skill group level statistics for each business segment for agent statuses (2203), calls type breakdown by segment subdivision (2205), overall all agent activities by agent ACD status (Ready for Call, Not Ready for Call, Call on Hold, ACW and Talking) (2207), and overall activates by agents for all combined aggregated contact centre (2209). It will be appreciated that the AHT variance is the difference between plan AHT and Actual AHT and indicates in seconds how far off the actuals are from planned performance. This allows for tracking service level challenges if an employee is taking longer than expected to complete a task (for example, a call centre agent answering clients).

FIG. 22E depicts a user interface showing historical and automated reporting for the front line queue statistics. The user has to option to select a metric to view results for each line of business and sub segment groups (2211). The metrics may include Service Levels, Average Speed of Answer, Occupancy, Call Offered, Calls Handled, Abandoned, Average Speed of Answer, Average Busy Time, Average Handle Time, Work time, and Talk Time. The user can select a line of business to view results (2213). The statistics are shown with results broken down by language (English, French and Combined) (2215), current day of the week which may include previous days (2217), current date (2219), business segment names (2221), overall total results (2223), combined results (English and French) (2225), and an option (2227) to extract reports, create alerts or subscribe to scheduled report delivery by email.

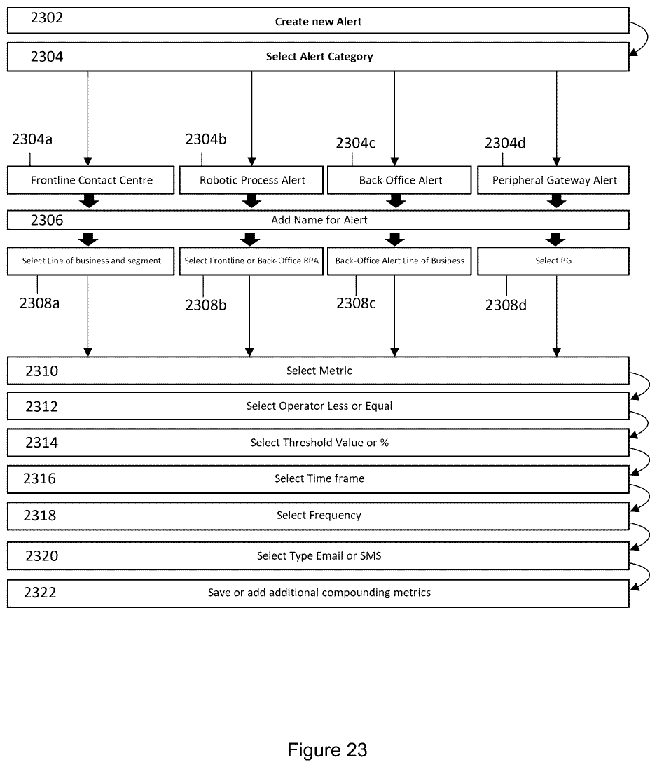

FIG. 23 depicts a method of creating an alert or report at the alert management layer 2118. A user may start the method by selecting a create new alert option 2302, and selecting an alert category 2304. The alert categories may comprise a frontline alert 2304a, RPA alert 2304b, back-office alert 2304c, and peripheral gateway (PG) alert 2304d. The RPA based alerts 2304b may comprise alerts for bot processing times, success rates and failure rates, and more. The back-office alerts 2304c may identify tickets in each category. PG alerts 2304d may identify any PG level system issues that are causing, for example, increased abandon rates. It will be appreciated that abandons can be tracked at each system level such as Network, PBX, ACD and Telephone Set Level.

The user may enter a particular name for the alert 2306, and then select the options and values they would like to be alerted about. The options can include: selecting line of business and segment (2308a), selecting frontline or back-office RPA (2308b), selecting back-office alert line of business (2308c), and selecting the peripheral gateway (2308d), each of which may respectively correspond to frontline alert 2304a, RPA alert 2304b, back-office alert 2304c, and peripheral gateway (PG) alert 2304d. Further, the user may identify the metric (2310), operator (2312), threshold value or percent (2314), time frame (2316), frequency of alerts (2318), to receive the alerts by email or text (2320), save or add additional metrics (2322), and more. The system receives all of the selections by the user, and automatically alerts the user based on the selections.

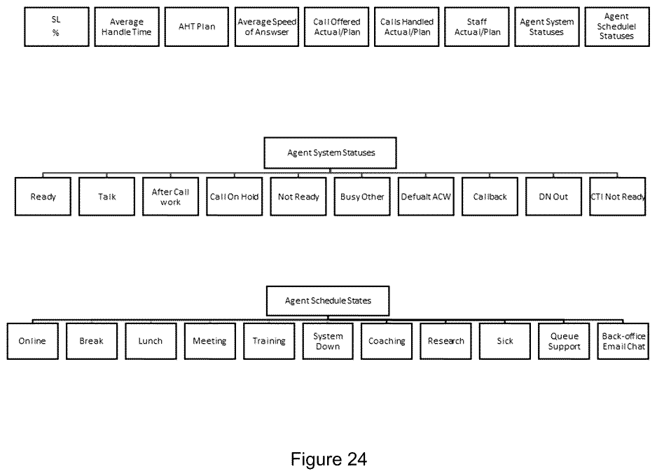

FIG. 24 depicts various frontline metrics available for the alerts. It will be appreciated that these alerts can be set on a compounding basis: set together or as a combination of 2 or more. For example, a user can select to be alerted if the SL conditions are below a certain percent and also if the Staffing or System Down time is above a certain percent. This allows for a smarter alert based on a combination of metrics meeting a certain criteria.

The queue monitor tool allows for ongoing monitoring, tracking, and identifying of issues in RPA in real-time and assigning key resources to troubleshoot and rectify the failure.

The updates include real time updates that provide live dashboard monitoring of success rates by process. The real time updates allow for the identification of any potential issue in real-time. Within minutes of an issue being reported, a monitoring RPA resource acknowledges the issue within the system and performs some basic system checks to eliminate any basic issues. If the issue is still not resolved, the resource automatically engages a level 1 support assigned to provide support depending on where the issue is identified as. The system and resource further generate a detailed report of incident which is issued to the users such as stakeholders to advise of the ongoing troubleshoot and expected resolution time. The system allows for the current dashboard to be inserted within the report so that no additional work is required. The report may also provide a guided flow of troubleshoot steps to go through.

General updates may also be provided. The RPA monitoring resource issues periodic updates to the users on the ongoing state of operations. This report may include any prior issues, all current completion rates, and transaction counts. The first report of each day ensures that all systems and applications are functioning as they should. The system allows the prime or personnel dedicated to the task to issue these updates directly to users. Any RPA support teams may further add comments to the updates being sent out.

All support teams and resource contacts are listed within the system such that the prime can quickly assign a support resource by contacting the respective support. The system provides a schedule of the support teams and the RPA primes. This schedule may be accessed by particular users to allow for employees to be reassigned resources and to change their schedule. It will be appreciated that the RPA primes may be a team of employees dedicated to the RPA system.

### Virtual Manager Tool

A virtual management system or tool manages day to day operations of a workforce and ensures that service conditions and standards are met for each day. The system is used to monitor any changes in work conditions and adapt accordingly to mitigate any service issues, basing any recommendations on cost and performance, to thereby optimize the workforce.

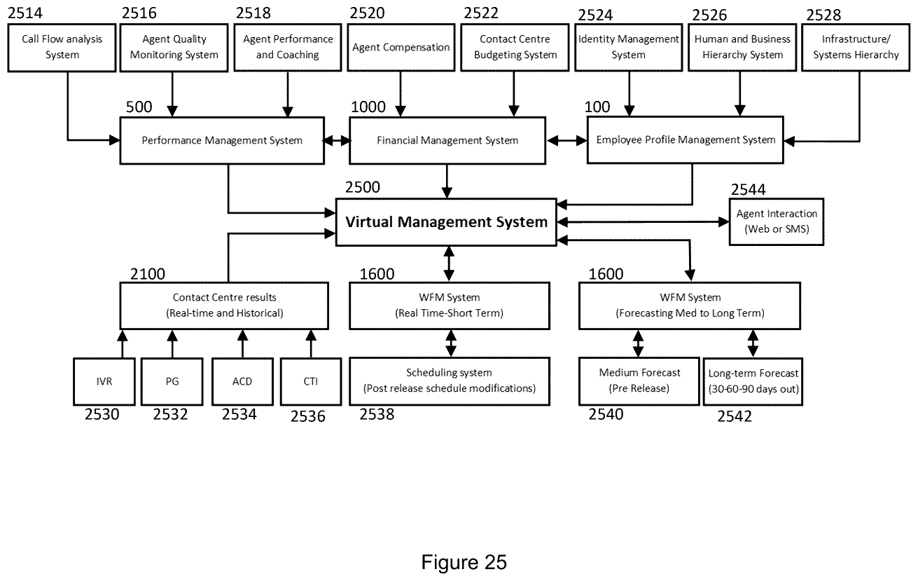

FIG. 25 depicts an overview of the virtual manager system 2500. The system quickly updates absences, employees who are late, and system issues any employees may have based on input from one or more employees and data stored in the system. The system also provides recommended actions and can generate overtime and time-off offers to particular employees based on a work schedule, employees' input, and performance and cost data stored in the system. The system may automatically provide recommendations for next step strategies based on absences, time off or overtime possibilities, and the performance and cost data.

The virtual manager system 2500 comprises the hierarchy system 100 (employee profile management system), the agent suite system 500 (performance management system), the budget tool 1000 (financial management systems), the WFM system 1600 for real time to short-term forecasts and for medium to long term forecasts, and the queue monitor 2100 (results in real-time and historical). The virtual manager system 2500 is capable of using all aggregated data points from the various systems to provide recommendations and to conduct interactions with employees.

The performance management system 500 (agent suite system as described above) captures KPI results for all employees. It allows users such as management staff or supervisors to monitor results for their operations. The system may provide dashboards, reports, and performance outcomes against a set target or object to be generated and displayed for the user. The system 500 monitors results of employees and presents the results to the user to ensure customers receive good quality service. The user can also identify the best-performing employees based on the generated and displayed information.

The performance management system 500 can receive and aggregate data from an analysis system 2514, an employee quality monitoring system 2516, and from employee performance and coaching systems 2518. The analysis system 2514 may be a call flow analysis system, for call centre operations, or may be another relevant system for the flow of work tasks. The analysis system 2514 analyzes, for example, call flows of employees based on guided call flows. The analysis allows managers or supervisors to ensure consistency of service delivery. The results of the analysis system 2514 are captured as part of data aggregation within the performance management system 500. The employee quality monitoring system 2516 comprises a specialized software for capturing audio and screen capture records of employees' client interactions. Employees' performance is recorded on a real time basis to create a customized performance or skills upgrade plan according to the need of the particular employee. The performance and coaching systems 2518 store and transmit data regarding the coaching or training received by an employee and the performance before and after the coaching. This allows the efficacy of the coaching and training to be measured and analysed. Businesses may use KPIS to achieve certain objectives, and set targets for employees based on the KPIs. For example, for call centres, employees may be measured based on how long they take to complete a call, over commonly known as Average Handle Time. This KPI along with a mix of different KPIs that address different customer expectation criteria may be used to analyse an employee's performance and relevant coaching or training may be provided based on one or more KPIs. It will be appreciated that if only one KPI, such as average handle time, is used, an employee could end their calls earlier to achieve better performance for such a KPI. However, this may negatively impact a customer's experience, and as such multiple KPIs may be used along with real-time information from employee analysis and employee quality monitoring systems to better analyse performance. A combination of KPIs relevant to a business allow for a scorecard to be created against which the employee performance is measured against rather then independent metrics. The coaching system is for addressing any performance gaps between teams and allow supervisors to ensure that the employees receive the right amount of instruction, motivation and encouragement to deliver better results.

The financial management system 1000 (budget tool as described above) allows for the overall financial planning and execution of a business to be managed. A management team can use the system to allocate costs accurately and assign all cost components appropriately. The financial management system 1000 can receive and aggregate data from an employee compensation system 2520 and a budgeting system 2522. The employee compensation system 2520 tracks and allows users to create and distribute compensation plans suited to the business needs. The plans may comprise incentive, bonus and payout policies. This information is stored and used in combination with other financial details such the budgetary allocation and spend tracking to identify the true cost for each individual employee as well as for each of its business segments and larger vendor groups. The budgeting system 2522 allows for creation of a budget, such as a ‘bottoms up’ budget, which includes basic demand and supply assumptions, and additional cost components and performance assumptions to address staffing requirements to meet a pre-determined customer demand. The budget may also be a ‘top down’ budget to cut costs by a given amount. The budgeting system 2522 incorporates and presents all cost and performance related assumptions to a user based on various decisions for the business.

The employee profile management system 100 (hierarchy system as described above) allows for tracking individuals within a business in an organized hierarchical manner. It follows a multi layered approach to connect individuals based on skill sets, language abilities, business segmentation that they belong to, report to structure, system ID, and more. The employee profile management system 100 can receive and aggregate data from an identity management system 2524, a human and business hierarchy system 2526, and from infrastructure/systems hierarchy 2528.

The identity management system 2524 manages individual system IDs and access control protocols that are in place in an organization. By tracking each system identity, the system captures all actions performed by employees within a billing system. This further allows for the results within a performance management system 500 to be captured. The human and business hierarchy system 2526 tracks each individual within a team and report to structure through a human layer and connects that with a business layer. The system 2526 provides a snapshot of the number of resources each side of business domain has based on employees skills, geolocation, business segments and other similar criteria. This allows for future planning and resources assignment to be possible. For example, a business benefits having a higher-up view of the number of resources in each domain to determine which resources can be placed where when needed. The infrastructure/systems hierarchy 2528 is a repository-based system which captures all the different types of infrastructure and technologies that a business would have. The infrastructure/systems hierarchy 2528 captures components and records any changes and facilitates any modification. For example, a contact centre can identify different call types that it receives by labelling and identifying them. This can be done based on components such as the type of customer inquiry, preferred language of the customer, whether they are deemed as high value, whether they are deemed to be highly likely to churn, and more. These call types may be assigned to groups and subgroups of employees that are skilled accordingly to assist these type of clients. The components captured link directly to individual employees and allow the virtual management system 2500 to identify the right employee for particular tasks or clients, and link all the associated technologies and systems that the component belongs to.

The work results system 2100 (queue monitor tool as described above) stores all real-time and historical recorded results for reporting purposes. It aggregates data from a wide variety of infrastructure sources, such as IVR 2530, PG 2532, ACD 2534, and computer telephony integration (CTI) 2536. IVR systems 2530 record the number of clients currently with in the IVR system, waiting to be served, or have already been helped by or been transferred to an employee. The PG 2532 is layered between IVR, routing solution and ACD systems and gathers real time information on the tasks being performed. The ACD system 2534 receives and distributes tasks such as calls within an environment such as a contact centre type environment. The CTI 2536 acts as an integration point between telephony systems and agent desktop, and allows employees to control a contact state with client. For example, for a call centre the employee may place the client on hold, transfer the client, answer or hang-up calls.

The WFM system 1600 (as described above) provides real-time management of service conditions and makes adjustments to optimize cost and customer experience. The WFM system 1600 receives and aggregates data from a scheduling system 2538. The scheduling system 2528 allows for post release schedule modifications to be communicated and updated. The updates may be made by the system through interactions with employees and confirmations of any schedule change requests. It will be appreciated that the post release refers to the time period after employee schedules are released, which may be 3-4 weeks at a time. Any modifications within such a time period are considered post release modifications. The post release medication are done through direct updates and API level modifications within the scheduling system 2538.

The WFM system 1600 also provides medium to long term planning and forecasting level changes based on changing needs from the business. The WFM system 2512 and the virtual management system 2500 may offer recommendations to the business and users for vendors or partners to use based on vendors and sites that are best performing or have lowest cost options.

The WFM system 1600 and the virtual management system 2500 aggregate data from the performance management system 500 that may track both individual and vendor level aggregate results for each segment and then provide a ranking for each vendor and site under each business segment, the system is able to provide performance-based recommendations. In addition, as the virtual manager 2500 aggregates all financial data for making a cost-based decision, it is able to provide cost-based recommendations using algorithms to identify the lowest cost options. It will be appreciated that these recommendations can be provided for a medium or long term basis.

The WFM system 1600 may be utilized for pre-release schedules 2540 (medium forecasts), and can recommend securing additional hours based on vendor and site performance or costs. The recommendations provided by WFM system 1600 may also be used for long-term forecasts 2542 through a combination of cost and performance criteria.

The virtual management system 2500 may be used to provide real time targeted communications to reach out to the relevant employee pools for overtime offers or time off offers taking into account performance and costs using all of the systems of the virtual management system (such as, the financial system through the budget tool, the performance management system or agent suite, the hierarchy tool, queue monitor system and others). The system 2500 uses business hierarchy and leadership structure to identify the relevant employee pools and then collects the contact information to generate an SMS distribution service or other distribution service to enable SMS messaging or other messaging for the relevant employees.

The virtual management system 2500 may also be used to receive and send shift trade requests, absence and vacation notifications, and system issues through SMS and web application systems based on input from a user. The system 2500 also receives, for example, another user's acceptance of the trade request and updates the schedule based on the trade, absence or system issues, through the various systems. A user can submit the information to the virtual management system 2500 through a user interface on a cellphone or web application.

Based on input from a user, and managers or supervisors of the user, the virtual manager system 2500 records the total number of absence reports for the running year and automatically notifies the employee's direct leader of the absences. The virtual management systems also links with HR records and systems to recommend that additional information be collected about the absences, if needed. For example, if as per the labour agreement, the employee has to submit a doctor's note on the fifth such absence, the system 2500 is programmed to advise the Team Leader or supervisor to collect the note.

The system 2500 allows the users to report any system issues as soon as they happen. This ensures that the schedule quickly reflects this important change and the real time managers are fully aware of employees that are going to be offline for different reasons. For example, during work form home scenarios, an internet outage may be difficult to predict and report, the virtual management system allows this information to be collected via SMS and then updates the schedule immediately. It will be appreciated that if a large-scale outage is reported, the system 2500 identifies the outage to, for example, an IT service manager to initiate support protocols.

As described above, the virtual management system 2500 can provide smart recommendations based on all of the data aggregated for the various systems. The recommendations may include cost based options, by identifying the cheapest option based on relevant available employees and vendors cost per hour for, for example, overtime requested or when time is needed to be covered. This system 2500 allows for pre-determined budgets to be met and not exceeded. The recommendations may include performance-based options, as the performance management system 500 provides the best performing employees. The system 2500 can identify these high performing employees as possible alternates when addressing the time needs. The recommendation may comprise a ‘scorecard’ with a combination of metrics specific to the business segment and weights for the metrics. The scorecard allows users to view a holistic performance objective achieved rather than a single KPI.

Users can interact with the system 2500 through hand held devices via SMS, or through web-based applications (2544). Users can view their performance ranking and scores immediately allowing them to be able to view and track their results anytime and anywhere.

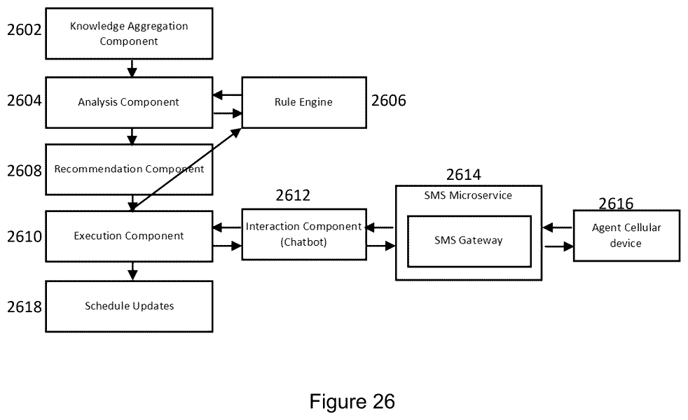

FIG. 26 depicts an embodiment of the functioning of the virtual management system 2500. The virtual management system comprises a knowledge and aggregation component (storage system 2602) for storing and combining all relevant data points such as work results, employee performance, financial, and hierarchy components to create and generate an aggregated data view of the environment. Data from the knowledge and aggregation component is received by an analysis component 2604. The analysis component 2604 analyzes the received data and compares it to pre-determined organizational specific analysis and rules via a rule engine 2606. The analysis component 2606 outputs information based on the comparison to a recommendation component 2608. The recommendation component 2608 generates one or more recommendations based on the received information, and sends the recommendations to an execution component 2610. It will be appreciated that the recommendations may be sent to a user for acceptance before execution. The execution component 2610 allows for a schedule to be updated based on the recommendations, and based on interactions with one or more users. If the recommendation comprises offering overtime to a particular group of employees, for example, an interaction component 2612, such as a chatbot, communicates with employees via SMS or web-based applications to offer and receives acceptance for the overtime. The employee may communicate with the interaction component 2612 via their cellular device 2616. The interaction component 2612 further allows users to request current schedules, report absences or system issues and more. The requests and communications may be processed through a SMS microservice 2614 which allows an SMS Gateway to interact with the user and vice versa.

The execution component 2610 receives updates from the interaction component and allows for the schedule update transaction to be completed through a scheduling software (2618).

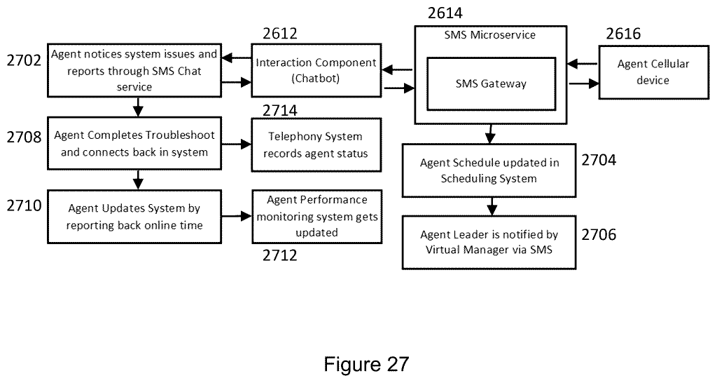

FIG. 27 depicts an embodiment of the functioning of the virtual management system 2500 when a system issue is reported. When a user determines that there is a system issue with their system, or with the overall system, they can report the issue through the interaction component 2612 (2702). It will be appreciated that if the user is experiencing a system issue, they may not have access to the application or their computing device, and can report the system issue through the SMS microservice 2614 and their cellular device 2616. The user may specify the start time of the outage through the interaction component 2612 as well. The virtual manager system 2500 receives the report and automatically updates the particular user's schedule based on the start time to identify that the user was not/is not available (2704). The system 2500 may further communicate the particular user's issues to the particular user's manager or supervisor (2706). The manager or supervisor may be notified by the interaction component 2612 via the web application or SMS.

The user may then attempt various troubleshooting means to resolve the system issue (2708). It will be appreciated that the system may provide standard expected response times, associated troubleshoot paths, and escalation contacts for many or all situations. The users may determine different or their own troubleshooting steps as well. Once the system issue is resolved, the user can report that the issue is resolved through the interaction component 2612 (2710). The system 2500 then updates the schedule to identify that the user is available based on the end time of the system issue (2704), and updates the user's performance monitoring system based on the timing of the issue (2712). The system 2500 may further communicate that the particular user has resolved their issues to the particular user's manager or supervisor (2706). The telephony system may record the user's status as available or not available during and after the system outage, respectively (2714).

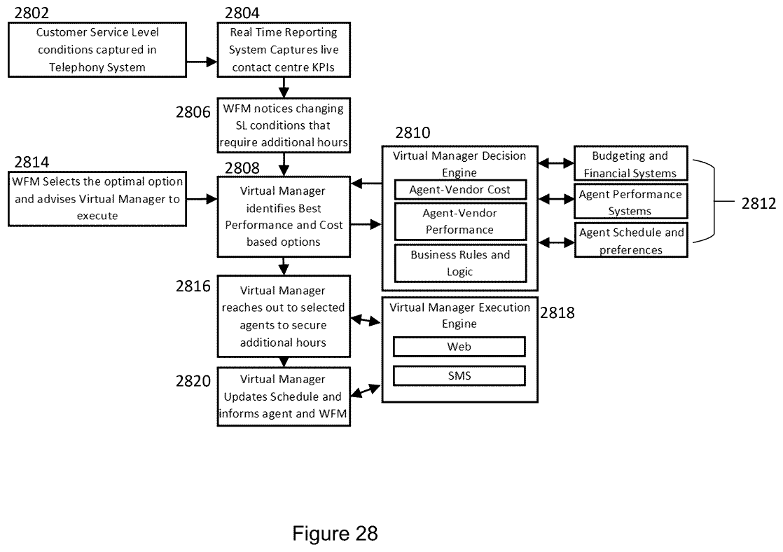

FIG. 28 depicts an embodiment of the functioning of the virtual management system 2500 for creating or generating an overtime request. A user, such as a manager, may identify that there is a need for additional hours based on service level (SL) conditions recorded by the telephony system (2802), and reported by a real time reporting system that reports live KPIs (2804). The user can report such a need in the virtual manager system 2500 (2806) (via the interaction component) by creating an overtime request. The virtual manager system 2500 generates recommendations (2808), as described above. The system 2500 may generate 3 recommendations, or more or less, depending on the settings of the system. The recommendations are cost-based recommendations and performance based-recommendations, which are generated based on an assessment of the request and the cost, by the virtual management system 2500 (2810). The recommendations may further include recommendations with the highest performance and lowest cost, or in other words recommendations that are both performance and cost based. The assessment analyses the employee and/or vendor costs, the performance data of the employee and/or vendor, and any rules and logics pre-set in the system. The virtual management system 2500 may aggregate and analyse data from budgeting and financial systems, performance systems, schedules, and hour preferences of employees (2812) to generate the recommendations.

The cost-based recommendations provide the lowest cost options for offering the overtime to. They are calculated using the employee specific and vendor specific rates. The system may check how many hours of overtime can be applied for each employee or vendor and also check to ensure maximum hours for the day are respected. The performance-based recommendations provide the best employees for offering overtime to. They are determined using the performance management system for calculating the overall performance of each employee or vendor rather than on individual metrics. This allows the employees or vendors with the best overall scorecards to be recommended for overtime hours.

The recommendations are presented to the user for selection from. The user may provide additional factors for the system 2500 to consider when generating the recommendations, which prompts the system 2500 to automatically adjust the recommendations. The system 2500 will receive the selection by the user, and will execute the selected recommendation (2814). The system 2500 communicates with the selected employees to offer additional hours (2816), via the interaction component 2612 through SMS and/or the web application (2818). Upon receipt of acceptance of the overtime offer from the employee, the system 2500 updates the schedule, informs the employee, and the user who initially made the overtime request (2820).

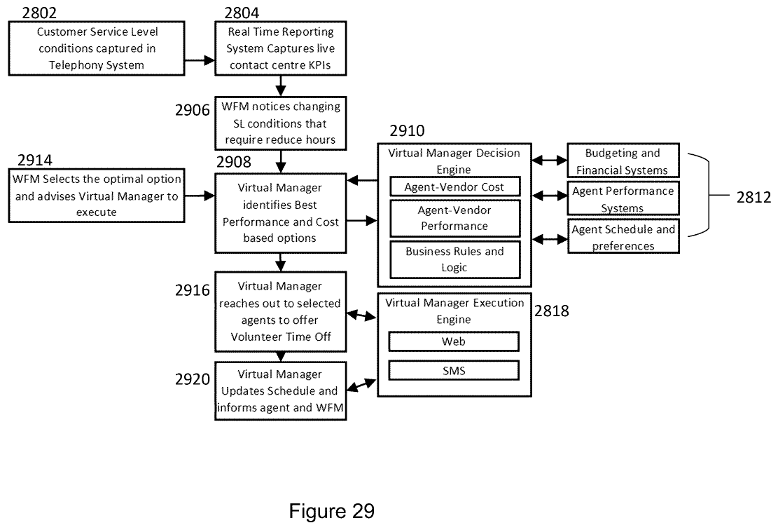

FIG. 29 depicts an embodiment of the functioning of the virtual management system 2500 for creating or generating a time off offer. A user, such as a manager, may identify that time off may be offered to certain employees or vendors based on favourable service level (SL) conditions recorded by the telephony system (2802), and reported by a real time reporting system that reports live KPIs (2804). The user can request such an offer be generated in the virtual manager system 2500, via for example the interface of the system (2906) by creating a request to reduce hours. The virtual manager system 2500 generates options for the time off offer to be sent to (2908). The system 2500 may generate 3 options/recommendations, or more or less, depending on the settings of the system. The recommendations are cost-based recommendations and performance based-recommendations, which are generated based on an assessment of the request, the cost, performance and other factors, by the virtual management system 2500 (2910). The recommendations may further include recommendations with the highest performance and lowest cost, or in other words recommendations that are both performance and cost based. The assessment analyses the employee and/or vendor costs, the performance data of the employee and/or vendor, and any rules and logics pre-set in the system. The virtual management system 2500 may aggregate and analyse data from budgeting and financial systems, performance systems, schedules, and hour preferences of employees (2812) to generate the options/recommendations.

The cost-based options provide the most expensive employees or vendors to offer time off to. The options are generated considering all labour laws that require minimum hours of work guaranteed for the day and week. The performance based options provide the lowest performing employees or vendors to offer time off to. The system 2500 aggregates employees and vendors 3 months performance, so the option may be generated based on the preceding three months of performance.

The options/recommendations are presented to the user for selection from. The user may provide additional factors for the system 2500 to consider when generating the recommendations, which prompts the system 2500 to automatically adjust the recommendations. The system 2500 will receive the selection by the user, and will execute the selected option (2914). The system 2500 communicates with the selected employees to offer time off (2916), via the interaction component 2612 through SMS and/or the web application (2818). Upon receipt of acceptance of the time off offer from the employee, the system 2500 updates the schedule, informs the employee, and the user who initially made the time off request (2920).

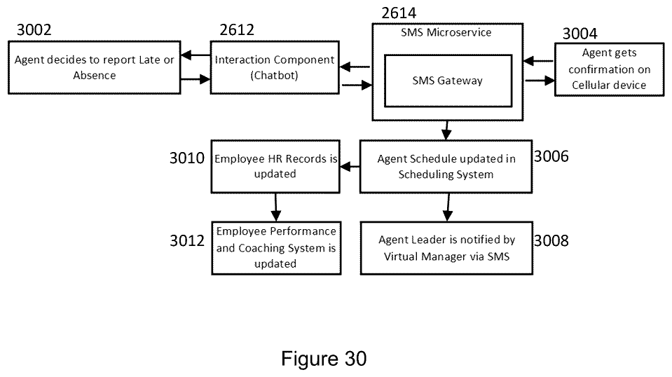

FIG. 30 depicts an embodiment of the functioning of the virtual management system 2500 for reporting lateness and absence. If a user is late for their work shift, or will be absence due to various circumstances, the user can report such lateness or absence to the system 2500 (3002) via the interaction component 2612 through SMS or web-based applications. The report is processed by an SMS micro service 2614 or other similar service, such that the user receives a confirmation from the system 2500 once the report has been processed (3004). The system 2500 updates the schedule based on the report (3006), and communicates the lateness or absence to the user's manager or supervisor (3008). The schedule update causes the employee HR record (3010) and the employee performance and coaching system (3012) to be updated.

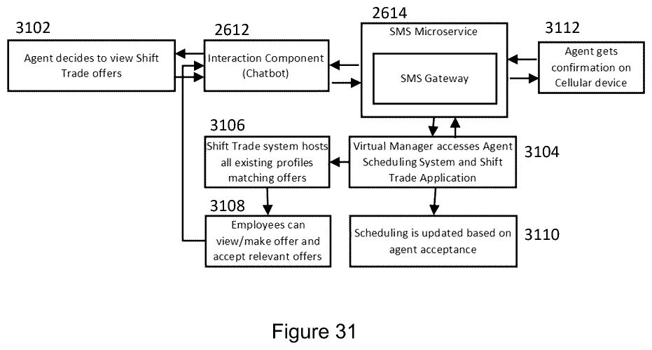

FIG. 31 depicts an embodiment of the functioning of the virtual management system 2500 for offering, viewing and accepting shift trades. If a user would like to trade work shifts, offer shifts, or pick up shifts, for any number of reasons, the user can submit such a request to a shift trade application component within system 2500 (3102). The request may be made via the interaction component 2612 through SMS or web-based applications. The request is processed by an SMS micro service 2614 or other similar service, such that the system 2500 accesses the relevant schedules and shift trade requests already submitted (3104). Any matching or similar requests or offers are determined by the system 2500 based on the employees making or looking for offers. The system 2500 may then present one or more options for a particular shift to be traded for another shift, indicating the days and times of the shifts, and/or one or more options of shifts being offered (3106). The user can view, offer, and/or accept a shift trade based on the options being presented (3108), via the interaction component 2612. The system 2500 automatically updates the schedule based on the user's selections (3110) and sends confirmations of the shift trade to the respective user and employees (3112).

It will be appreciated that each of the features of the virtual management system 2500 allow users to interact quickly and via SMS or web applications to request or view various schedules and schedule changes, and/or to make various updates. The results of the interactions are automatically communicated to supervisors or managers, and allow for the automatic update of information and data in the various systems of the virtual management system 2500. This allows for performance, coaching, HR, and other systems always be up to date. The recommendations generated the system 2500 are based on the data and information of these systems and are run through a rules engine which ensures all vendor specific, labour specific, and country specific regulatory rules are respected. The recommendations may be modified or overridden by a user.

The above described systems and methods allow for the operations of a business to be optimized. The data obtained, recorded, outputted, and analysed by the tools may be used with one or more of the other tools or may be used with other systems to accurately update and store information. The virtual management system 2500 depicts an embodiment of each of the tools and systems working together. In some embodiments, only one tool or system may be used by the virtual management system, or one or more tools or systems may be combined for various business requirements.

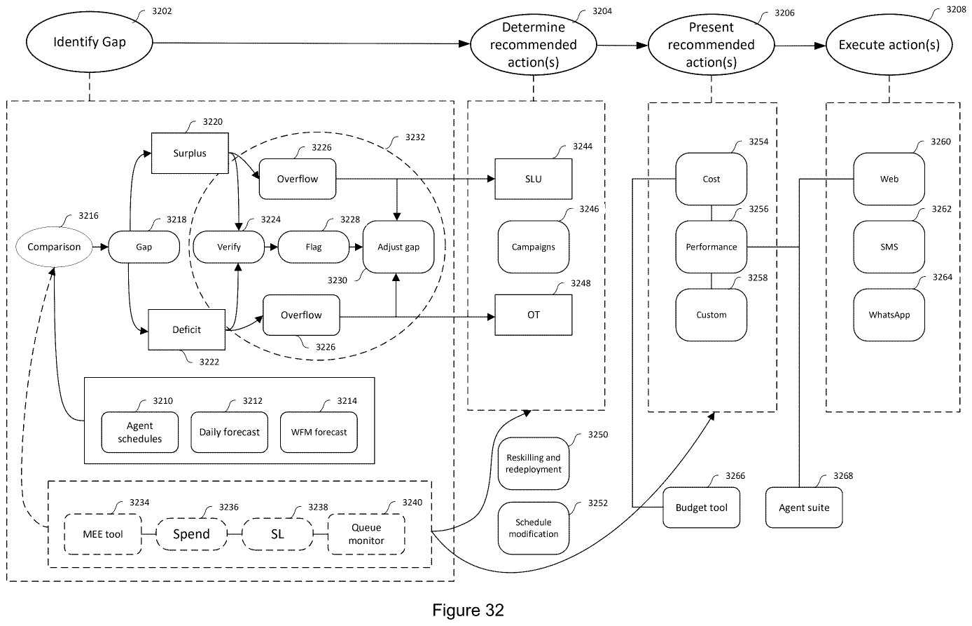

FIG. 32 depicts an embodiment of the functioning of the virtual management system for determining a gap in business operations and recommended actions for workforce optimization.

As seen in FIG. 32, the virtual management system determines a gap (3202), determines recommended action(s) (3204), presents the recommended actions to a business user (3206), and executes selected actions (3208).

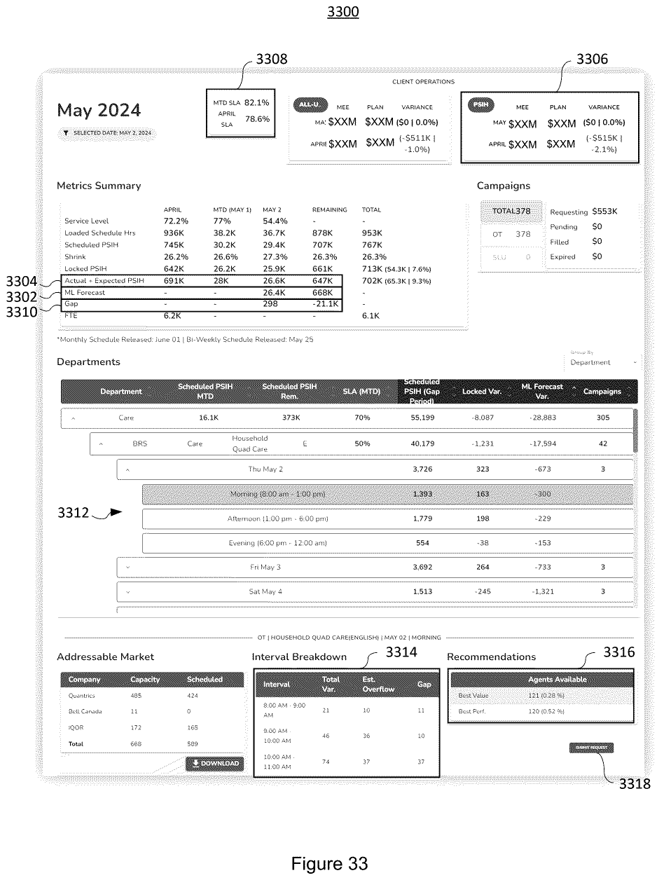

A user such as a workforce management (WFM) analyst is required to estimate the current demand and supply conditions to arrive at a conclusion whether additional supply is needed or not to continue to meet service standards already established by the organization. Determining the gap (3202) based on a comparison (3216) between demand side and supply side of employee requirements and availability simplifies the work of a WFM analyst that is required to understand what the upcoming service conditions will look like in an upcoming period of time (e.g. the next 2-4 weeks). The virtual management system can output various information to the WFM analyst to assist with decision making, and FIG. 33 depicts an example of a user interface 3300 generated by the virtual management system, which is referenced below.

Demand Side: In a call center implementation, determining the demand begins by understanding a current call volume that is arriving at the call centres to produce a daily forecast (3212). The virtual manager uses a T−1 (Today minus 1) daily-level Machine Learning-based forecast that recalculates the expected volume and projects the call volume for the remainder of the month so that the WFM team can better prepare for the expected volume. The user interface 3300 shows the ML forecast 3302. This allows the WFM team to accommodate for any spikes or emerging trends with the recent days and can account for demand level modifications that occurred after the original forecasting plan was created (i.e. using the workforce planning tool). As most common forecasting plans are created 60-90 days in advance they are devoid of any recent changes in the market conditions such as marketing offers or competitive offers that might require a reforecast. As described in more detail below, the virtual manager tool uses a Root Mean Square Error (RMSE) system to self-identify the best fit model when comparing all the models against previous day actual call volumes. It uses RMSE as a way to measure the accuracy of error of a model in predicting quantitative data. RMSE is ideal in situations that have varying levels of complexity and is an established statistical measurements for identifying the best model. It also keeps track of the actual locked forecast which was used by WFM Forecasting analyst to request the partners to schedule employees.

Supply Side: On the supply or agent side, the system connects with the scheduling system to identify all the agent schedules (3210) and the workforce management forecast (3214) for an upcoming period of time (e.g. the next 4-6 weeks). The supply side may then apply two layers of shrink assumptions on the schedules. A first assumption may look at previous rolling 4 weeks to capture the trend of incidental unpaid shrink and applying the difference to what is already coded in schedules. A second assumption may look at the recent Paid Shrink trend and applies the difference on existing coded Paid Shrink in scheduling system. These two layers of shrink allow the system to accurately capture the recent trends in supply (paid and unpaid) as both impact the availability of the agents to answer customer inquiries. The system can also capture the recent yield of schedules vs. actual PSIH (Productive Sign In Hours), which is a measure of real delivered online hours by agents as a reflection of the current yield and then applies that percentage to arrive at Expected PSIH. Expected PSIH is the final outcome on a daily basis which is broken down to interval levels to estimate gaps when compared to forecast for the same period. The user interface 3300 shows the Actual and Expected PSIH 3304.

Spend and SL Guidance: The system may also provide a subcomponent of Automated Month End Estimates (MEE) using MEE tool 3234 which captures the estimated end-of-month spend (3236) based on all the current actuals for the organization (e.g. contact center). Spend details help the WFM analyst understand the current trajectory and to be able to determine if the organization is currently trending to be overspend or underspend compared to a planned spend for that time period. For example, the user interface 3300 shows a month end estimate, a planned spend, and variance at 3306. This information helps a WFM analyst ensure that before any mitigation steps are taken there is a good understanding of the expected cost and its impact on the overall operational spend. Similarly, Service Levels (SLs) (3238) are determined for different groups based on queue monitor (3240) and displayed to allow the user to understand the current gaps in SL standards. The user interface 3300 shows service levels at 3308.

The gap (3218) is determined based on a comparison of the Expected PSIH and ML Forecast for the same period to determine either a surplus (3220) or a deficit (3222). The daily gap may be further broken down by departments and by intervals. Each interval level gap may be compared to a gap threshold that is user adjusted within the application. This allows the user to modify the threshold level for either the daily level (overall for the day) or for each interval level (Morning, Afternoon and Evening). The gap may be verified (3224), and if incorrect based on a manual review of employee schedules, a flag (3228) may be generated and the gap adjusted (3230). The user interface 3300 shows the gap calculation 3310, the gap for a given department and interval 3312, and a further gap interval breakdown 3314.

Overflow Adjustment: The gap may be compared to expected schedules for all agents that are similarly skilled and can be potentially invoked as part of the contingency by WFM. This allows the system to determine an available overflow (3226) and more accurately estimate the right number of hours that are still gapped. The system may identify the cross segments that are able to support these segments and then identify if there is overcapacity in those queues or not. If there is overcapacity meaning they can support the ‘overflow’ then an adjustment is made by reducing the gap hours. This makes the gap even more accurate. Employee information (such as from the hierarchy tool) can provide the agent skill sets (e.g. primary and secondary) and the virtual manager can estimate the needs for each segment/queue and then utilizes any spare capacity for overflow needs. Doing this allows for more accurately understanding what the real gap is expected to be once the built-in system capacity is taken into account.

Determining one or more recommended action(s) (3204) may include creating campaigns (3246), such as overtime campaigns (3248) or special leave unpaid (3244), to address the gap having identified how many hours by each segment for each language by each interval is available/required. The virtual manager may determine how many hours per tactic is required and create targeted system-generated offers based on automatic gap identification, whereas previously the WFM team would use open-ended offers to anyone and everyone that can answer these calls. A user can set Service Level Thresholds, i.e. a percentage threshold for service level guidance that may be used to determine when to invoke campaigns or not. Additionally or alternatively, a user can set a Campaign Trigger Threshold as an overall gap threshold for the day or for each interval level.

With the virtual manager, the system can automatically identify the intervals that will require additional supply (OT) or will have spare capacity (SLU). This allows the WFM team to specifically target the exact gap by each interval by balancing the expected service conditions with the least amount of money spent on it. By each block of interval the user can view the identified gap and create recommended actions including matching campaigns complete with estimated cost and performance impact. The system also indicates the current scheduled capacity as well as the unscheduled capacity. The virtual manager can account for any local labor related restrictions that might be in-place, such as minimum or maximum hours for the week or month based on employment status. The virtual manager can also ensure that any contractual details are also taken into account that are vendor specific. This allows a WFM analyst to view the total addressable market. One option available is to target all eligible agents when invoked, which will target all agents that can take up additional hours based on labor requirements. The system can also indicate if it excluded certain agents due to vacation, sick leaves, etc., providing complete transparency to the business user.

Additional tactics to mitigate the gap beyond overtime and special leave unpaid are also possible, such as schedule modifications (3250) and/or skills updates (3252).

Schedule Modification: If the system identifies the gap it may also identify any agents that have a same day work schedule so that their shift can be modified to be moved to earlier opening. This will allow a change to release schedule and can be used a rebalancing or schedule optimization. This is one of the no cost options to the organization as it can easily modify a shift given that there is enough notice to the agents. This allows for flexibility and agility in execution without costing the organization.

Skill Updates: Skills and modification of skills based on business needs require updates into several downstream system and is usually a very manual activity. The system allows for WFM admin to make these changes and tactics by quickly identifying which agents may be required as part of a contingency exercise. For example, the WFM analyst might request some Outbound-only type agents to take Inbound calls for a limited time if they are already skilled to do so. This change of tactic would require re-skilling in Telephony systems. The Virtual Manager solution makes these modifications simple and easy to execute by removing the human components and the transactions can be implemented directly within the system.

Recommended action(s) are presented (3206). That is, the virtual manager automatically creates multiple options for WFM analyst, which may for example include performance-based (3254), cost-based (3254), or custom (3258) options. Performance-based option short lists the best performing agents first but will continue to add more agents if it requires more resources. Performance metrics may be obtained from the agent suite tool (3268). The value/cost-based option calculates the cost based on effective rate for each vendor and segment and assigns best performing agents with the least cost, and it also continues to add more agents as needed. The cost-based metrics may for example be obtained from the budget tool (3266). The user interface 3300 shows recommendations 3316, including a number of agents available based on best value and best performance.

The virtual manager can execute the recommended action(s) (3208). The user interface 3300 shows a button 3318 to enable one-click execution by the user. The virtual manager can connect offers directly with agents to reduce the manual effort required to coordinate with agents and update the schedules. The virtual manager may reach out to agents via a web application (3260) or mobile (e.g. SMS (3262), WhatsApp (3264)) through a self enrolled process.

As described above, machine learning models are used in both the demand side forecasting and also for supply side forecasting that is used for scheduling. The workforce planning tool as described above can make forecasting predictions a set number of days in advance (e.g. 30, 45, 60 days, etc.) that is used to schedule employees. For determining the demand side, a daily ML forecast can be run that accounts for actuals from the day before. The T1 ML forecast runs for all segment and language employee combinations using all models (in this implementation, 25 models) available and then uses RMSE for calculating the best recommended model for uniquely forecasting the daily demand (which may be broken down for each segment/language combination).

The T1 model may be the same or different model than the model used for scheduling by the workforce planning tool (e.g. a T45 model, i.e. a 45 day forecast). In some implementations, T1 runs every day and determines the RMSE for every model based on daily actuals. If the RMSE for T1 remains similar (+−5%) to the Best selected model from T45, then the same model may be used with the updated T1 numbers. Otherwise the model with the lowest T1 RMSE may be used. For example if T45 selected Multiple Seasonal-Trend decomposition using LOESS (MSTL) with exponential smoothing (ETS) as the model for the T45 forecast, then the same model may continue to be used for T−1 predictions using the updated actual data as long as the actuals are within a 5% range of the previous forecast.

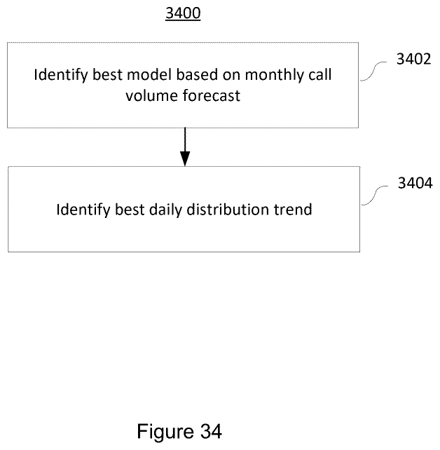

A methodology for determining the best T1 model for daily distribution is described with reference to FIG. 34. The method 3400 for selecting a model for daily forecasting comprises identifying the best model based on a monthly call volume forecast (3402) and identifying the best distribution trend for daily distribution (3404).

For identifying the best model based on a monthly call volume forecast, a plurality of models are evaluated based on the accuracy of their predictions/forecasts predicted a certain time in advance relative to the actual call volume. For example, a monthly call volume prediction may occur a minimum 60 days prior the actual forecasted month (e.g. on March 31st for June prediction) using latest three month actuals. Each of the plurality of models is run for 60 day predictions based on latest three month actuals, and produce daily forecast results which are aggregated for monthly volume. The models are tested for weighted Root Mean Squared Error (RMSE) and compared and ranked for variance to actual call volumes. The model with lowest RMSE can be automatically identified as recommended model for Call Volume forecast for each Segment and Language combination The best daily distribution (i.e. monthly call volume conversion to daily level) is identified by comparing different recent distribution trends (for example, 4 week, 6 week, 8 week, and 13 week trends). Different trends are compared to latest 3 month actuals to select the trend providing the lowest RMSE to the actual volumes. The best trend distribution is selected to break down best pick monthly call volume.

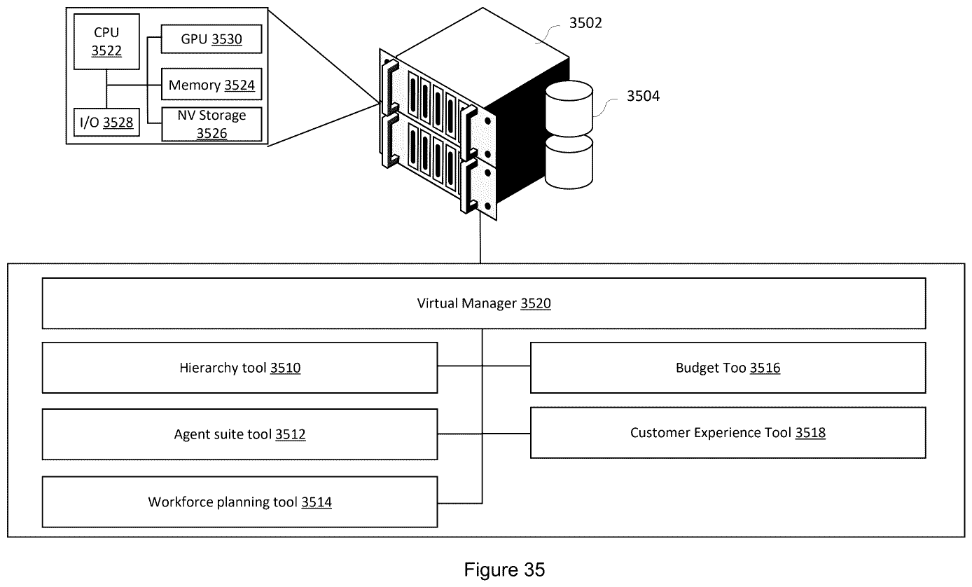

FIG. 35 depicts a representation of a workforce optimization system. The system comprises one or more servers 3502 and associated database(s) 3504. The one or more servers 3502 are configured to implement various tools as described herein, including a hierarchy tool 3510 configured to collect and store employment information about employees of a workforce; an agent suite tool 3512 configured to collect and store employee performance data and scheduling information for the employees; a workforce planning tool 3514 configured to determine forecasted employee requirements (e.g. which may for example correspond to the WFM tool described above); a budget tool 3516 configured to determine an expected budget based on the employment information and the forecasted employee requirements; a customer experience monitoring tool 3518 configured to determine a service level provided by the employees to customers (e.g. which may for example correspond to the queue monitor tool described above); and a virtual manager 3520. The virtual manager 3520 is configured to analyze the employment information, the employee performance data, the scheduling information, the forecasted employee requirements, the expected budget, and the service level, and determine one or more recommended actions for optimizing the workforce while maintaining the service level at or above a minimum service level. It will be appreciated that there may be multiple servers 3502 implemented as part of the system, and that multiple servers 3502 may be networked together and collectively perform the methods disclosed herein using distributed computing.

The server(s) 3502 each comprise a CPU 3522, a non-transitory computer-readable memory 3524, a non-volatile storage 3526, an input/output interface 3528, and may also comprise graphical processing units (“GPU”) 3530. The non-transitory computer-readable memory 3524 comprises computer-executable instructions stored thereon at runtime which, when executed by the CPU 3522, configure the server to perform a workforce optimization method. The non-volatile storage 3526 has stored on it computer-executable instructions that are loaded into the non-transitory computer-readable memory at runtime. The input/output interface 3528 allows the server to communicate with one or more external devices (e.g. via a network). The GPU 3530 may be used to control a display and may also be used to implement aspects of the method (e.g. running the machine learning models).

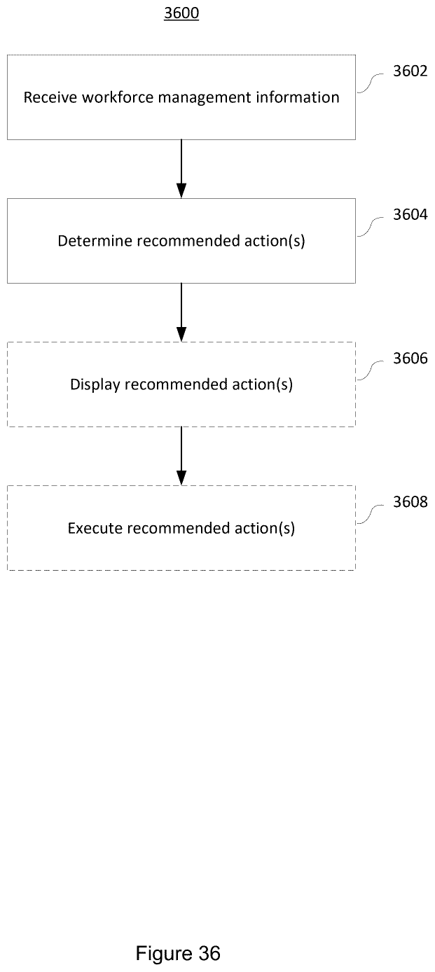

FIG. 36 depicts a workforce optimization method 3600. The workforce optimization method 3600 may be performed by the one or more server(s) 3502, in particular by the virtual manager tool implemented at the one or more servers. Computer-readable instructions may be stored in the non-transitory computer-readable memory 3524 and executed by the CPU 3522 to configure the server(s) 3502 to implement the workforce optimization method 3600.

The method 3600 comprises receiving workforce management information (3602). The workforce management information comprises employment information about employees of a workforce, performance data of the employees, scheduling information about the employees, forecasted employee requirements, an expected budget, and a service level provided by the employees to customers. For example, the workforce management information may be received from the hierarchy tool, agent suite tool, workforce planning tool, budget tool, and customer experience monitoring tool as described above.

One or more recommended actions for optimizing the workforce are determined while maintaining the service level at or above a minimum service level (3604). The one or more recommended actions may comprise one or more of: generating overtime offers to one or more employees; and determining, based on the scheduling information, one or more available employees for scheduling. The one or more employees and/or the one or more available employees may be identified/determined based on performance and/or based on cost.

For example, determining one or more recommended actions for optimizing the workforce may comprise determining a gap between a current expected demand for employee requirements and a supply of employee availability, and determining the one or more recommended actions to minimize the gap. The current expected demand can be determined by forecasting employee requirements for a current interval. Forecasting the employee requirements for the current interval may comprise using a machine learning model selected from a plurality of machine learning models based on accuracy of previous forecasted employee requirements compared to actual employee requirements. Determining the supply of employee availability may be based on an actual and expected employee availability, wherein the actual and expected employee availability is determined based on the employment information, the scheduling information, and the forecasted employee requirements.

Additionally or alternatively, the method may comprise determining a variance between an expected actual budget for a time period and a planned budget for the time period, and to determine the one or more recommended actions to minimize the variance. The planned budget for the time period may be determined for the time period based on the employment information, the scheduling information, and the forecasted employee requirements at a time of creating the planned budget, and the expected actual budget for the time period may be determined based on the employment information, the scheduling information, and the forecasted employee requirements at a current time. The method may further comprise using a machine learning model trained on historical employee requirements to determine the forecasted employee requirements. Determining the expected budget may be further based on fixed and variable cost components, and agent productivity expectations.

The method 3600 may further comprise displaying the recommended action(s) 3606 to a user. For example, the method may comprise generating a user interface for display to a user, the user interface displaying information of one or more of the employment information, the scheduling information, the forecasted employee requirements, the expected budget, the service level, and the one or more recommended actions.

The method 3600 may further comprise implementing the one or more recommended actions (3608). The recommended action(s) may be implemented in response to user input (e.g. received in the user interface), or automatically implemented.

Various other functionality may be performed as part of the method 3600. For example, the method may further comprise determining recommended coaching and/or training for employees based on the performance data. The method may further comprise setting targets and incentives to the employees, where the incentives may for example comprise commissions and/or bonuses, and the targets and incentives may be set for individual employees or a group of employees. The method may also further comprise determining and storing current and historical service levels.

The workforce optimization method may be used to optimize employees of a call center, and the forecasted employee requirements based on a forecasted call volume.

It will be apparent to persons skilled in the art that a number of variations and modifications can be made without departing from the scope of the invention. Although specific embodiments are described herein, it will be appreciated that modifications may be made to the embodiments without departing from the scope of the current teachings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure.

When used in this specification and claims, the terms “comprises” and “comprising” and variations thereof mean that the specified features, steps or integers are included. The terms are not to be interpreted to exclude the presence of other features, steps or components.

The invention may also broadly consist in the parts, elements, steps, examples and/or features referred to or indicated in the specification individually or collectively in any and all combinations of two or more said parts, elements, steps, examples and/or features. In particular, one or more features in any of the embodiments described herein may be combined with one or more features from any other embodiment(s) described herein.

1. A workforce optimization system, comprising:
a hierarchy tool configured to collect and store employment information about employees of a workforce;
an agent suite tool configured to collect and store employee performance data and scheduling information for the employees;
a workforce planning tool configured to determine forecasted employee requirements;
a budget tool configured to determine an expected budget based on the employment information and the forecasted employee requirements;
a customer experience monitoring tool configured to determine a service level provided by the employees to customers; and
a virtual manager configured to analyze the employment information, the employee performance data, the scheduling information, the forecasted employee requirements, the expected budget, and the service level, and determine one or more recommended actions for optimizing the workforce while maintaining the service level at or above a minimum service level.

2. The workforce optimization system of claim 1, wherein the virtual manager is configured to determine a gap between a current expected demand for employee requirements and a supply of employee availability, and to determine the one or more recommended actions to minimize the gap.

3. The workforce optimization system of claim 2, wherein the virtual manager determines the current expected demand by forecasting employee requirements for a current interval.

4. The workforce optimization system of claim 3, wherein forecasting the employee requirements for the current interval comprises using a machine learning model selected from a plurality of machine learning models based on accuracy of previous forecasted employee requirements compared to actual employee requirements.

5. The workforce optimization system of claim 2, wherein the virtual manager determines the supply of employee availability based on an actual and expected employee availability, wherein the actual and expected employee availability is determined based on the employment information, the scheduling information, and the forecasted employee requirements.

6. The workforce optimization system of claim 1, wherein the one or more recommended actions comprise one or more of:
generating overtime offers to one or more employees; and
determining, based on the scheduling information, one or more available employees for scheduling.

7. The workforce optimization system of claim 6, wherein the one or more employees and/or the one or more available employees are determined based on performance and/or based on cost.

8. The workforce optimization system of claim 1, wherein the virtual manager is configured to determine a variance between an expected actual budget for a time period and a planned budget for the time period, and to determine the one or more recommended actions to minimize the variance.

9. The workforce optimization system of claim 8, wherein the planned budget for the time period is determined for the time period using the budget tool based on the employment information, the scheduling information, and the forecasted employee requirements at a time of creating the planned budget, and wherein the expected actual budget for the time period is determined using the budget tool based on the employment information, the scheduling information, and the forecasted employee requirements at a current time.

10. The workforce optimization system of claim 1, wherein the workforce planning tool uses a machine learning model trained on historical employee requirements to determine the forecasted employee requirements.

11. The workforce optimization system of claim 1, wherein the agent suite tool is further configured to determine recommended coaching and/or training for employees based on the performance data.

12. The workforce optimization system of claim 1, wherein the agent suite tool is further configured to set targets and incentives to the employees.

13. (canceled)

14. The workforce optimization system of claim 12, wherein the targets and incentives are set for individual employees or a group of employees.

15. The workforce optimization system of claim 1, wherein the budget tool determines the expected budget further based on fixed and variable cost components, and agent productivity expectations.

16. The workforce optimization system of claim 1, wherein the customer experience tool determines and stores current and historical service levels.

17. (canceled)

18. (canceled)

19. The workforce optimization system of claim 1, wherein the virtual manager is configured to generate and output a user interface for display to a user, the user interface displaying information of one or more of the employment information, the employee performance data, the scheduling information, the forecasted employee requirements, the expected budget, the service level, and the one or more recommended actions.

20. The workforce optimization system of claim 19, wherein the virtual manager is configured to implement the one or more recommended actions in response to user input.

21. The workforce optimization system of claim 1, 20, wherein the virtual manager is configured to automatically implement the one or more recommended actions.

22. A workforce optimization method, comprising:
receiving workforce management information, the workforce management information comprising employment information about employees of a workforce, performance data of the employees, scheduling information for the employees, forecasted employee requirements, an expected budget, and a service level provided by the employees to customers; and
determining one or more recommended actions for optimizing the workforce while maintaining the service level at or above a minimum service level.

23.-42. (canceled)

43. A non-transitory computer-readable medium having computer executable instructions stored thereon which, when executed by a processor, configure the processor to implement a method comprising:
receiving workforce management information, the workforce management information comprising employment information about employees of a workforce, performance data of the employees, scheduling information for the employees, forecasted employee requirements, an expected budget, and a service level provided by the employees to customers; and
determining one or more recommended actions for optimizing the workforce while maintaining the service level at or above a minimum service level.
